(19) United States
(12) Patent Application Publication
(10) Pub. No.: US 2026/0091708 A1
(43) Pub. Date: Apr. 2, 2026

(54) COORDINATED OPTIMIZATION METHOD AND SYSTEM FOR HYDROGEN FUEL CELL VEHICLE, DEVICE, AND MEDIUM

(71) Applicant: STATE GRID ZHEJIANG JIASHAN POWER SUPPLY CO., LTD., Zhejiang (CN)

(72) Inventors: Qingsheng LIU, Zhejiang (CN); Yiping CHEN, Zhejiang (CN); Kai MENG, Zhejiang (CN); Zhongyuan SHEN, Zhejiang (CN); Yanmin ZHAO, Zhejiang (CN); Jinwei CHEN, Zhejiang (CN); Yong HE, Zhejiang (CN)

(73) Assignee: STATE GRID ZHEJIANG JIASHAN POWER SUPPLY CO., LTD., Zhejiang (CN)

(21) Appl. No.: 19/289,112

(22) Filed: Aug. 4, 2025

(30) Foreign Application Priority Data
Sep. 30, 2024 (CN) 202411376157.4

(51) Int. Cl. B60L 58/30; B60L 50/70; B60L 58/40; H01M 8/04298; H01M 8/0432; H01M 8/04537; H01M 8/04701; H01M 8/04746; H01M 8/04858

(52) U.S. Cl. CPC B60L 58/30; B60L 50/70; B60L 58/40; H01M 8/04305; H01M 8/0432; H01M 8/04619; H01M 8/04708; H01M 8/04716; H01M 8/04753; H01M 8/04761; H01M 8/0488; H01M 8/0491; H01M 8/04947

(57) ABSTRACT

A coordinated optimization method and system for a hydrogen fuel cell vehicle, a device, and a medium. The method includes: determining a target output voltage and a target output current corresponding to a stack in a hydrogen fuel cell vehicle; determining a sub-stack efficiency score corresponding to one of sub-stacks, and determining a sub-stack stability score corresponding to the sub-stack; obtaining a comprehensive score of the sub-stack efficiency score and the sub-stack stability score, and determining a primary stack and a secondary stack from the sub-stacks according to a comprehensive score result; generating, according to the target output voltage and the target output current, a primary stack output parameter corresponding to the primary stack and a secondary stack output parameter corresponding to the secondary stack; and dynamically adjusting an operating state of the primary stack, and dynamically adjusting an operating state of the secondary stack.

### CROSS-REFERENCE TO RELATED APPLICATION

This application claims the priority benefit of China application serial no. 202411376157.4, filed on Sep. 30, 2024. The entirety of the above-mentioned patent application is hereby incorporated by reference herein and made a part of this specification.

### BACKGROUND

### Technical Field

The present application relates to the technical field of fuel cells, and in particular, to a coordinated optimization method and system for a hydrogen fuel cell vehicle, a device, and a medium.

### Description of Related Art

Hydrogen fuel cell vehicles are an important way to ensure a power system, and are mainly applicable to ensuring load power in important meetings, large-scale events, important examinations, power overhaul, and other scenarios. Currently, it is difficult for a single fuel cell stack to satisfy a real-time power demand of high-power vehicles. To satisfy the demand of the hydrogen fuel cell vehicles, a hydrogen fuel cell pack is composed of a plurality of hydrogen fuel cell reactors connected in parallel, with a power density of 700 W/kg and a service life of up to 30000 h.

However, voltages of different cell stacks may vary in a case of parallel stacks, which leads to non-uniform current distribution. One cell stack is likely to output more current while another cell stack is less burdened. This voltage difference may lead to unstable operation of the cell stacks, affecting the overall efficiency and life. In addition, internal resistances of the cell stacks may vary due to manufacturing differences, service lives, and other factors. Differences in the internal resistances will lead to non-uniform current distribution. Even at a same voltage, power outputs of different cell stacks may be different. This difference may be caused by aging of the cell stacks, temperature changes, and other factors.

Therefore, an effective method is required to optimize and adjust outputs of a plurality of cell stacks, to ensure uniform load sharing and overall stability of the hydrogen fuel cell vehicles.

### SUMMARY

The present application provides a coordinated optimization method and system for a hydrogen fuel cell vehicle, a device, and a medium, which resolve a technical problem of how to optimize and adjust outputs of a plurality of cell stacks, thereby achieving a technical effect of ensuring uniform load sharing and overall stability of the hydrogen fuel cell vehicle.

To achieve the foregoing object, the present application adopts the following main technical solutions.

According to a first aspect, an embodiment of the present application provides a coordinated optimization method for a hydrogen fuel cell vehicle. The method includes:
determining, based on an obtained target load demand of a hydrogen fuel cell vehicle, a target output voltage and a target output current corresponding to a stack in the hydrogen fuel cell vehicle, where the stack includes at least two sub-stacks connected in parallel;
determining, for each sub-stack, a sub-stack efficiency score corresponding to the sub-stack and a sub-stack stability score corresponding to the sub-stack;
obtaining a comprehensive score of the sub-stack efficiency score and the sub-stack stability score, and determining a primary stack and a secondary stack from the sub-stacks according to a comprehensive score result;
generating, according to the target output voltage and the target output current, a primary stack output parameter corresponding to the primary stack and a secondary stack output parameter corresponding to the secondary stack by using a preset output characteristic model; and
dynamically adjusting an operating state of the primary stack according to the primary stack output parameter, and dynamically adjusting an operating state of the secondary stack according to the secondary stack output parameter, to satisfy a target load demand.

According to the coordinated optimization method for a hydrogen fuel cell vehicle provided in this embodiment, the target output voltage and the target output current of the stack are determined based on the obtained target load demand, so that the stack can be dynamically adjusted according to a real-time load demand. This adjustment may optimize power outputs of the stack under different operating conditions, thereby improving the overall performance and efficiency of the hydrogen fuel cell vehicle. Then, the stack includes at least two sub-stacks connected in parallel, and the performance of each sub-stack may be accurately evaluated by determining efficiency scores and stability scores of the sub-stacks. It is beneficial to identify lower-performance sub-stacks and optimize or replace the sub-stacks, thereby ensuring the reliability and stability of the entire stack. Then, roles of the primary stack and the secondary stack are determined by the comprehensive score, which is beneficial to allocate resources to a stack with optimal performance. The primary stack undertakes a main energy conversion task, while the secondary stack serves as an auxiliary or standby stack. This allocation improves the overall efficiency and reliability of the hydrogen fuel cell vehicle. Based on the output parameters of the primary stack and the secondary stack generated by the preset output characteristic model, the operating state may be accurately adjusted to ensure that the output of the stack meets the target load demand, and dynamic response capability and operating efficiency are improved, thereby improving the overall performance of the hydrogen fuel cell vehicle.

Optionally, the determining, based on an obtained target load demand of a hydrogen fuel cell vehicle, a target output voltage and a target output current corresponding to a stack in the hydrogen fuel cell vehicle includes:
obtaining a current load demand of the hydrogen fuel cell vehicle;
performing data smoothing on the current load demand by using Kalman filtering, to obtain a smoothed target load demand; and
generating, according to the target load demand, the target output voltage and the target output current corresponding to the stack by using a preset fuzzy rule library.

In this embodiment, the current load demand is obtained, and load demand data may be effectively smoothed by using Kalman filtering, thereby eliminating the impact of noise and outliers. Therefore, a data sequence is more stable and reasonable. This processing can improve the reliability of data, thereby improving the accuracy of the response of the stack to load changes. Then, by using the preset fuzzy rule library, the target output voltage and target output current of the stack are generated according to the smoothed target load demand. Therefore, the output of the stack can be optimized under various load conditions, thereby ensuring the performance and efficiency of the hydrogen fuel cell vehicle.

Optionally, the determining a sub-stack efficiency score corresponding to the sub-stack includes:
obtaining an output voltage, an output current, a hydrogen flow, and an oxygen flow of the sub-stack over a preset period of time;
determining an average output voltage of the output voltages over the preset period of time, and determining an average output current of the output currents over the preset period of time;
determining, according to the average output voltage and the average output current, an average output power corresponding to the sub-stack;
inputting the hydrogen flow and the oxygen flow to a preset power conversion model, to generate an average input power corresponding to the sub-stack; and
determining the sub-stack efficiency score according to a ratio of the average output power to the average input power.

In this embodiment, the output voltage, the output current, the hydrogen flow, and the oxygen flow of the sub-stack are obtained over a preset period of time, and an average value of the output voltage and the output current is calculated, so that the impact on momentary fluctuation can be reduced, evaluated voltage and current values are more representative, and the actual performance of the sub-stack can be better reflected. The average output power calculated based on accurate voltage and current data provides necessary data for performance evaluation of the sub-stack. By inputting hydrogen and oxygen flow data into the power conversion model, an energy demand of the sub-stack may be effectively estimated, thereby evaluating the energy efficiency and operating state thereof. Finally, by calculating a ratio of the output power to the input power, the efficiency of the sub-stack may be accurately evaluated. The efficiency score intuitively reflects an energy efficiency level of the sub-stack and helps to optimize the performance and energy utilization efficiency thereof.

Optionally, the determining a sub-stack stability score corresponding to the sub-stack includes:
obtaining an output voltage and an output current of the sub-stack over a preset period of time;
determining a voltage standard deviation of the output voltage over the preset period of time, and determining a current standard deviation of the output current over the preset period of time; and
determining, according to the voltage standard deviation and the current standard deviation, the sub-stack stability score by using a preset stability score model.

In this embodiment, the output voltage and the output current of the sub-stack over a preset period of time are obtained, and the stability is measured by calculating a standard deviation of voltage and current. The standard deviation reflects the fluctuation of data, so as to evaluate the performance of the sub-stack. The standard deviation is converted into a stability score, which makes the stability evaluation of the cell more intuitive and quantitative, and is convenient for comparison and decision.

Optionally, the obtaining a comprehensive score of the sub-stack efficiency score and the sub-stack stability score, and determining a primary stack and a secondary stack from the sub-stacks according to a comprehensive score result includes:
weighting the sub-stack efficiency score and the sub-stack stability score, to obtain a comprehensive score;
clustering the sub-stacks to obtain stack clusters separately including one or more sub-stacks;
determining intra-cluster representative features of the stack clusters, and determining, for any stack cluster, a stack feature set to which the intra-cluster representative features belong;
obtaining risk factors of the stack feature sets, and screening out a candidate stack feature set based on the risk factors; and
sorting the comprehensive scores of the sub-stacks in descending order in the stack cluster corresponding to the candidate stack feature set, determining a sub-stack corresponding to the highest comprehensive score as the primary stack, and determining the remaining sub-stack as the secondary stack.

In this embodiment, a comprehensive performance evaluation is provided by comprehensively considering the sub-stack efficiency score and the sub-stack stability score by a weighted summation method. This method can balance different performance indexes and ensure that a final score is more representative. Then, the sub-stacks are classified by using a clustering algorithm, so that the sub-stacks with similar performance can be classified into a same cluster, thereby simplifying subsequent analysis and decision processes. The intra-cluster representative features are determined, thereby effectively reducing the data complexity and improving the efficiency and accuracy of feature selection. By calculating and screening out the risk factors, it is ensured that the risk of the selected stack feature set is minimal, thereby enhancing the safety and reliability of stack selection. According to the comprehensive score and risk evaluation results, the sub-stack with the highest comprehensive score is selected as the primary stack, and the remaining sub-stack serves as the secondary stack. It is beneficial to optimize the configuration of the stack while ensuring the performance.

Optionally, the preset output characteristic model includes a support vector machine, a decision tree, and a random forest. The primary stack output parameter includes a primary output voltage, a primary output current, and a primary output power. The secondary output parameter includes a secondary output voltage, a secondary output current, and a secondary output power. The generating, according to the target output voltage and the target output current, a primary stack output parameter corresponding to the primary stack and a secondary stack output parameter corresponding to the secondary stack by using a preset output characteristic model includes:
generating, according to the target output voltage and the target output current, a primary output voltage corresponding to the primary stack and a secondary output voltage corresponding to the secondary stack by using the support vector machine;
generating, according to the target output voltage and the target output current, a primary output current corresponding to the primary stack and a secondary output current corresponding to the secondary stack by using the decision tree; and
generating, according to the target output voltage and the target output current, a primary output power corresponding to the primary stack and a secondary output power corresponding to the secondary stack by using the random forest.

In this embodiment, the primary output voltage of the primary stack and the secondary output voltage of the secondary stack may be accurately predicted by using the support vector machine. The decision tree can generate the primary output current of the primary stack and the secondary output current of the secondary stack by analyzing the target output voltage and the target output current. The random forest can generate the primary output power of the primary stack and the secondary output power of the secondary stack by training a plurality of decision trees and integrating the results thereof. By using three different machine learning models, namely the support vector machine, the decision tree, and the random forest, the voltage, current, and power of the primary stack and the secondary stack in the hydrogen fuel cell vehicle can be comprehensively and accurately predicted. This method optimizes the performance of the stack according to the target output parameter in complex practical applications of the hydrogen fuel cell vehicle, and improves the overall efficiency and stability of the hydrogen fuel cell vehicle.

Optionally, after the dynamically adjusting an operating state of the primary stack according to the primary stack output parameter, and dynamically adjusting an operating state of the secondary stack according to the secondary stack output parameter, the method further includes:
comparing the primary output voltage with the target output voltage, and re-adjusting, in a case that a difference in a comparison result exceeds a voltage deviation threshold, the operating state of the primary stack and the operating state of the secondary stack; and
comparing the primary output current with the target output current, and re-adjusting, in a case that a difference in a comparison result exceeds a current deviation threshold, the operating state of the primary stack and the operating state of the secondary stack.

In this embodiment, the primary output voltage and the primary output current of the primary stack are continuously monitored and adjusted when a deviation exceeds a set threshold, to ensure that the hydrogen fuel cell vehicle is always maintained within an expected performance range. In this way, fluctuations caused by the performance reduction of the primary stack or load changes can be effectively handled, thereby improving the overall operating stability and reliability of the hydrogen fuel cell vehicle. The coordinated operation of the primary stack and the secondary stack can be ensured, thereby optimizing the power output, ensuring that the target load demand is satisfied, and reducing a potential fault risk caused by the deviation.

Optionally, the method further includes:
obtaining, in a case that the stack is used in cooperation with a plurality of auxiliary power supplies, performance parameters of the auxiliary power supplies;
determining, according to the performance parameters, output power ranges corresponding to the auxiliary power supplies by using a preset performance-power range model; and
generating, according to a multi-objective optimization algorithm, an optimized power distribution scheme by maximizing a power supply efficiency, a device power supply reliability, and a device life as objective functions and by constraining output powers of the auxiliary power supplies to satisfy the output power range, where the device power supply reliability represents a proportion of time during which the target load demand is maintained.

In this embodiment, by using the auxiliary power supplies (a generator, a solar panel, and a lithium-ion battery pack) in cooperation, even if a main power supply has a fault, the auxiliary power supplies can continue to supply power, and the normal operation of the hydrogen fuel cell vehicle is ensured. The power generation efficiency of the generator, the maximum output power of the solar panel, and the capacity of the lithium-ion battery pack are monitored in real time, and the output power ranges of the auxiliary power supplies are determined according to the performance parameters of the auxiliary power supplies through the preset performance-power range model, so as to ensure that the hydrogen fuel cell vehicle can satisfy the real-time changing load demand and optimize the use efficiency of each auxiliary power supply. The power distribution scheme is generated by using the multi-objective optimization algorithm, the power supply efficiency, the device power supply reliability, and the device life are comprehensively considered, the best balance point can be found therefrom, and the overall performance can be improved.

Optionally, the auxiliary power supplies include a generator, a solar panel, and a lithium-ion battery stack.

The performance parameters include a power generation efficiency of the generator, a maximum output power of the solar panel, and a capacity of the lithium-ion battery pack.

Optionally, the generating, according to a multi-objective optimization algorithm, an optimized power distribution scheme further includes satisfying the following conditions.

The target load demand is equal to a sum of the output powers of the stacks and the output powers of the auxiliary power supplies.

The output power of each sub-stack is required to be within a design limit range.

Optionally, the objective function includes:

$$min {\sum }_{t = 1}^{24} [ {w}_{1} \times {a}_{i} + {w}_{2} \times {b}_{i} + {w}_{3} \times {c}_{i} ] ,$$

power supply efficiency=output power of stack or auxiliary power supply/target load demand,
where w₁, w₂, and w₃ are weight coefficients, αᵢ is the power supply efficiency of an i^{th} sub-stack or auxiliary power supply, bᵢ is the device power supply reliability of the i^{th} sub-stack or auxiliary power supply, and cᵢ is the device life of the i^{th} sub-stack or auxiliary power supply.

Optionally, the method further includes:
obtaining a temperature change rate and a current load power of each sub-stack, and determining a temperature change trend membership corresponding to the sub-stack by using a fuzzy logic algorithm, where the temperature change trend membership is configured for representing a fuzzification degree of a temperature change trend;
generating, according to the current load power and the temperature change trend membership, an adjusted power corresponding to the sub-stack; and
dynamically adjusting, according to the adjusted power, a flow, pressure, and temperature of hydrogen, a flow, pressure, and temperature of oxygen, and a flow, pressure, and temperature of water in the sub-stack.

In this embodiment, the temperature change rate and the load power of the sub-stack are obtained in real time by using the fuzzy logic algorithm, and are fuzzed into membership values, which can accurately reflect the actual operating state and temperature change trend of the sub-stack. Based on the fuzzy membership values and preset rules, an accurate adjusted power (including heating and cooling powers) is generated, to optimize the performance and stability of the sub-stack. The flows, pressures, and temperatures of hydrogen, oxygen and water are dynamically adjusted according to the adjusted power, to ensure that the sub-stack can maintain the optimal operating state under various load conditions, thereby improving the overall efficiency and prolonging the device life.

Optionally, the method further includes:
adjusting, in a case that the temperature change rate exceeds a preset temperature change threshold, a membership function in the fuzzy logic algorithm, to obtain an adjusted fuzzy logic algorithm;
determining, according to the adjusted fuzzy logic algorithm, an updated temperature change trend membership corresponding to the sub-stack;
generating, according to the current load power and the updated temperature change trend membership, an updated adjusted power corresponding to the sub-stack; and
dynamically adjusting, according to the updated adjusted power, the flow, pressure, and temperature of hydrogen, the flow, pressure, and temperature of oxygen, and the flow, pressure, and temperature of water in the sub-stack.

In this embodiment, by adjusting the membership function in the fuzzy logic algorithm, it is possible to handle the situation that a preset temperature change rate threshold is exceeded. This adjustment aims to improve the adaptability of the algorithm and ensure that a more accurate control policy can be generated when the temperature change rate is high, thereby optimizing the operating effect of the sub-stack.

Optionally, the method further includes:
determining a current runtime corresponding to the sub-stack;
determining, according to the target load demand, a predicted load power demand corresponding to the sub-stack over a future period of time by using a dynamic programming algorithm with an objective of prolonging the current runtime; and
dynamically adjusting, according to the predicted load power demand, a flow, pressure, and temperature of hydrogen, a flow, pressure, and temperature of oxygen, and a flow, pressure, and temperature of water in the sub-stack.

In this embodiment, the current runtime of the sub-stack is accurately calculated. Then, the dynamic programming algorithm is used to predict a future load power demand according to the target load demand. By modeling the historical load data and the current hydrogen inventory, future load conditions can be predicted and optimized, to achieve an objective of prolonging the runtime of the sub-stack. This prediction can not only improve the operating efficiency of the stack, but also make adjustments when the load fluctuates, to ensure the stack stability. The flows, pressures, and temperatures of hydrogen, oxygen and water are dynamically adjusted according to the predicted load power demand. This dynamic adjustment can accurately match the output power demand of the sub-stack and optimize the operating performance of a hydrogen fuel cell. This adjustment manner can adapt to different load conditions, thereby improving the overall efficiency and stability of the hydrogen fuel cell vehicle.

Optionally, the determining a current runtime corresponding to the sub-stack includes:
obtaining a current hydrogen inventory, a sub-stack efficiency, and a peak power demand of each sub-stack;
determining, according to the peak power demand and the sub-stack efficiency, a required hydrogen amount corresponding to the sub-stack; and
determining, according to the current hydrogen inventory and the required hydrogen amount, the current runtime corresponding to the sub-stack.

In this embodiment, by obtaining the current hydrogen inventory of the sub-stack, the sub-stack efficiency, and the peak power demand, the required hydrogen amount may be accurately calculated, thereby accurately determining a hydrogen demand of the sub-stack under various operating conditions. Further, according to a ratio of the current hydrogen inventory to the required hydrogen amount, the current runtime of the sub-stack can be estimated. This process provides an important basis for reasonable operation and maintenance planning.

Optionally, the dynamic programming algorithm includes:
determining, according to the predicted load power demand and the sub-stack efficiency, a predicted required hydrogen amount corresponding to the sub-stack;
determining a predicted runtime according to the current hydrogen inventory and the predicted required hydrogen amount; and
continuing to iteratively cycle, in a case that the predicted runtime is lower than the current runtime, the dynamic programming algorithm until the predicted runtime exceeds the current runtime, to obtain a predicted load power demand corresponding to the sub-stack.

In this embodiment, in combination with the predicted load power demand and the sub-stack efficiency, the required hydrogen amount of the sub-stack under future load conditions can be accurately calculated. Then, by calculating the ratio of the current hydrogen inventory to the predicted required hydrogen amount, the predicted runtime of the sub-stack is accurately estimated. Finally, the dynamic programming algorithm is continuously iterated and optimized until the predicted runtime exceeds the current runtime, thereby ensuring the accuracy of the predicted load power demand.

Optionally, the method further includes:
obtaining a current operating temperature and a current ambient temperature of the sub-stack;
enabling, in a case that the current operating temperature is lower than a preset operating temperature threshold and/or the current ambient temperature is lower than a preset ambient temperature threshold, a drainage heating function and a water storage and return function;
monitoring a liquid flow in a drainage heating process and a liquid level in a water storage and return process; and
determining an adjusted heating power and a stored water recovery rate according to the liquid flow and the liquid level, and performing dynamic adjustment according to the heating power and the stored water recovery rate.

In this embodiment, the operating temperature and the ambient temperature are monitored in real time. When the temperatures are lower than the preset thresholds, the drainage heating function and the water storage and return function are automatically enabled, to effectively prevent water inside a drainage pipe and the stack from freezing, thereby protecting the stack from being affected by low temperature. The liquid flow and the liquid level are monitored in real time, and the heating power and the water return rate are dynamically adjusted according to actual data, thereby ensuring the normal operation of the stack, preventing excessive or insufficient moisture, and optimizing the internal humidity of the stack.

Optionally, the method further includes:
obtaining a present current density, a current operating temperature, a temperature change rate, and a temperature change gradient of the sub-stack, and determining a load power demand corresponding to the sub-stack by using a preset first fuzzy control algorithm in combination with the target load demand;
determining, according to the load power demand and the temperature change gradient, an adjusted current density corresponding to the sub-stack by using a preset second fuzzy control algorithm; and
dynamically adjusting, according to the adjusted current density, a flow, pressure, and temperature of hydrogen, a flow, pressure, and temperature of oxygen, and a flow, pressure, and temperature of water in the sub-stack.

In this embodiment, the present current density, the current operating temperature, the temperature change rate, and the temperature change gradient of the sub-stack are obtained, and the data are processed by using the first fuzzy control algorithm. The operating state of the sub-stack can be accurately evaluated, and the load power demand can be predicted. Then, the second fuzzy control algorithm determines the adjusted current density according to the load power demand and the temperature change gradient. The current density can be dynamically adjusted during the operation of the sub-stack, to maintain the optimal operating state and efficiency of the stack. Finally, the flows, pressures, and temperatures of hydrogen, oxygen and water are dynamically adjusted according to the adjusted current density. The flows of gas and liquid in the sub-stack can be optimized in real time, to maintain the sub-stack under optimal operating conditions and ensure the operating stability and efficiency of the sub-stack, thereby improving the overall performance and responsiveness of the sub-stack.

Optionally, the method further includes:
obtaining weight distribution data of a compartment of the hydrogen fuel cell vehicle, and constructing a weight distribution matrix according to the weight distribution data, where the weight distribution matrix is configured for representing weight data of different regions of the compartment;
analyzing, according to the weight distribution matrix, the compartment by using finite element software, to obtain an overweight region; and
adjusting, according to the overweight region, a structural design parameter of the compartment by using the finite element software, and adjusting a structure of the compartment according to the structural design parameter.

In this embodiment, the weight distribution data of the compartment of the hydrogen fuel cell vehicle is obtained in real time, the weight distribution matrix is constructed according to the weight distribution data, and each element in the matrix represents the weight of the corresponding region. Then, the compartment is analyzed by using the finite element software, the overweight region of the compartment can be identified, the stress and bearing capacity of the compartment in actual use are evaluated, and a basis is provided for design optimization. The analysis results can reveal potential overweight regions, helping to discover and resolve structural problems in advance. According to the analysis results of the overweight region, the structural design parameter of the compartment, such as a material type, a thickness, or a geometrical shape, is adjusted. Through optimized design, the bearing capacity and stability of the compartment are enhanced, the load on the overweight region is reduced, and potential fault risks caused by insufficient design are reduced, thereby improving the reliability and durability of the overall structure.

Optionally, the structural design parameter includes a redistributed load. The adjusting a structure of the compartment according to the structural design parameter includes:
obtaining weights, sizes, and positions of devices in the compartment, and determining a centroid position of each device;
weighting the centroid positions to obtain an overall centroid position;
determining an offset between the overall centroid position and a geometric center of the compartment, and inputting, in a case that the offset is greater than a preset offset threshold, the weights, the sizes, the positions, the centroid positions, and the geometric center to a dynamic balancing algorithm, to generate a load adjustment scheme; and
adjusting the devices in the compartment according to the load adjustment scheme.

In this embodiment, basic data is provided for further calculating the centroid position by obtaining the weights, sizes, and positions of the devices in the compartment. Weighted calculation is performed on the centroid positions of all the devices, to obtain the overall centroid position. This weighting method combines mass and position data of all the devices, so that the overall centroid position can truly reflect the mass distribution of the devices in the whole compartment. The offset between the overall centroid position and the geometric center of the compartment is calculated, and compared with the preset threshold, to ensure the stability and safety of the compartment during transportation. If the offset exceeds the preset threshold, the dynamic balancing algorithm will generate the load adjustment scheme, to optimize the device layout to reduce a centroid offset, thereby improving the transportation stability of the compartment. Finally, according to the load adjustment scheme, the device is actually adjusted, to ensure that the overall centroid position is aligned with the geometric center. This not only improves the stability during transportation, but also effectively avoids potential safety hazards caused by the offset of the centroid.

According to a second aspect, an embodiment of the present application provides a coordinated optimization system for a hydrogen fuel cell vehicle. The system includes:
a target output determining module, configured to determine, based on an obtained target load demand of a hydrogen fuel cell vehicle, a target output voltage and a target output current corresponding to a stack in the hydrogen fuel cell vehicle, where the stack includes at least two sub-stacks connected in parallel;
an efficiency score and stability score module, configured to determine, for each sub-stack, a sub-stack efficiency score corresponding to the sub-stack and a sub-stack stability score corresponding to the sub-stack;
a comprehensive score module, configured to obtain a comprehensive score of the sub-stack efficiency score and the sub-stack stability score, and determine a primary stack and a secondary stack from the sub-stacks according to a comprehensive score result;
an output parameter determining module, configured to generate, according to the target output voltage and the target output current, a primary stack output parameter corresponding to the primary stack and a secondary stack output parameter corresponding to the secondary stack by using a preset output characteristic model; and
a dynamic adjustment module, configured to dynamically adjust an operating state of the primary stack according to the primary stack output parameter, and dynamically adjust an operating state of the secondary stack according to the secondary stack output parameter, to satisfy a target load demand.

According to the coordinated optimization system for a hydrogen fuel cell vehicle provided in this embodiment, the target output voltage and the target output current of the stack are determined based on the obtained target load demand, so that the stack can be dynamically adjusted according to a real-time load demand. This adjustment may optimize power outputs of the stack under different operating conditions, thereby improving the overall performance and efficiency of the hydrogen fuel cell vehicle. Then, the stack includes at least two sub-stacks connected in parallel, and the performance of each sub-stack may be accurately evaluated by determining efficiency scores and stability scores of the sub-stacks. It is beneficial to identify lower-performance sub-stacks and optimize or replace the sub-stacks, thereby ensuring the reliability and stability of the entire stack. Then, roles of the primary stack and the secondary stack are determined by the comprehensive score, which is beneficial to allocate resources to a stack with optimal performance. The primary stack undertakes a main energy conversion task, while the secondary stack serves as an auxiliary or standby stack. This allocation improves the overall efficiency and reliability of the hydrogen fuel cell vehicle. Based on the output parameters of the primary stack and the secondary stack generated by the preset output characteristic model, the operating state may be accurately adjusted to ensure that the output of the stack meets the target load demand, and dynamic response capability and operating efficiency are improved, thereby improving the overall performance of the hydrogen fuel cell vehicle.

According to a third aspect, an embodiment of the present application provides a computer device, including:
a memory and a processor, where the memory and the processor are in communication connection with each other. The memory has computer instructions stored therein. The processor executes the computer instructions to perform the foregoing coordinated optimization method for a hydrogen fuel cell vehicle.

According to a fourth aspect, an embodiment of the present application provides a computer-readable storage medium. The computer-readable storage medium has computer instructions stored therein. The computer instructions cause a computer to perform the foregoing coordinated optimization method for a hydrogen fuel cell vehicle.

### BRIEF DESCRIPTION OF THE DRAWINGS

To describe technical solutions in specific implementations of the present application or in the related art more clearly, the accompanying drawings required to be used in the descriptions of the specific implementations or the related art will be simply introduced below. It is apparent that the accompanying drawings described below are some implementations of the present application. Those of ordinary skill in the art may obtain other accompanying drawings according to these accompanying drawings without making creative efforts.

FIG. 1 is a flowchart of a coordinated optimization method for a hydrogen fuel cell vehicle according to an embodiment of the present application;

FIG. 2 is a flowchart of step S101 according to an embodiment of the present application;

FIG. 3 is a flowchart of determining a sub-stack efficiency score corresponding to a sub-stack in step S103 according to an embodiment of the present application;

FIG. 4 is a flowchart of determining a sub-stack stability score corresponding to a sub-stack in step S103 according to an embodiment of the present application;

FIG. 5 is a flowchart of step S105 according to an embodiment of the present application;

FIG. 6 is a flowchart of step S107 according to an embodiment of the present application;

FIG. 7 is a flowchart of cooperative use of auxiliary power supplies according to an embodiment of the present application.

FIG. 8 is a flowchart of temperature change adjustment according to an embodiment of the present application;

FIG. 9 is a flowchart of updated temperature change adjustment according to an embodiment of the present application;

FIG. 10 is a flowchart of prolonging runtime according to an embodiment of the present application;

FIG. 11 is a flowchart of step S501 according to an embodiment of the present application;

FIG. 12 is a flowchart of a dynamic programming algorithm according to an embodiment of the present application;

FIG. 13 is a flowchart of a heating water storage function according to an embodiment of the present application;

FIG. 14 is a flowchart of adjusting a current density according to an embodiment of the present application;

FIG. 15 is a flowchart of adjusting a weight distribution according to an embodiment of the present application;

FIG. 16 is a flowchart of adjusting a structure of a compartment according to a structural design parameter according to an embodiment of the present application;

FIG. 17 is a block diagram of a coordinated optimization system for a hydrogen fuel cell vehicle according to an embodiment of the present application; and

FIG. 18 is a schematic structural diagram of a computer device according to an embodiment of the present application.

### DESCRIPTION OF THE EMBODIMENTS

To make the objects, technical solutions, and advantages of embodiments of the present application clearer, the following clearly describes the technical solutions in the embodiments of the present application with reference to drawings in the embodiments of the present application. Apparently, the described embodiments are some rather than all of the embodiments of the present application. All other embodiments obtained by those of ordinary skill in the art based on the embodiments of the present application without making creative efforts shall fall within the protection scope of the present application.

As a protection tool for a power system, a hydrogen fuel cell vehicle mainly plays a role in important meetings, large-scale events, important examinations, power overhaul, and other scenarios. These application scenarios typically require a stable and reliable power supply. The hydrogen fuel cell vehicle can provide a necessary load support to ensure the normal operation of the power system at critical moments. A single hydrogen fuel cell stack cannot satisfy real-time power demands of high-power vehicles. Therefore, a plurality of cell stacks need to be used in parallel to form a hydrogen fuel cell pack. This configuration has a power density of 700 W/kg and a long service life (up to 30000 hours), which can satisfy high-power application demands. In a parallel configuration, voltages of different cell stacks may vary. Voltage differences may lead to non-uniform distribution of current. To be specific, some cell stacks may output more current while other cell stacks are less burdened. This unbalanced current distribution affects the stability, overall efficiency, and service life of the cell stacks. Internal resistances of the cell stacks may vary due to manufacturing differences, service time, and other factors. The differences in the internal resistances further increase the non-uniform current distribution. Even at a same voltage, power outputs of different cell stacks may be different. These differences may be caused by aging of the cell stacks, temperature changes, and other factors.

To ensure the stability and efficiency of the hydrogen fuel cell vehicle, effective optimization and adjustment methods are needed to achieve uniform load sharing, thereby ensuring the overall stability of a multi-cell stack system.

According to the embodiments of the present application, an embodiment of a coordinated optimization method for a hydrogen fuel cell vehicle is provided. It should be noted that steps shown in the flowchart of the accompanying drawings may be executed in a computer system including, for example, a set of computer-executable instructions. In addition, although a logical order is shown in the flowchart, in some cases, the steps shown or described may be executed in a different order than herein.

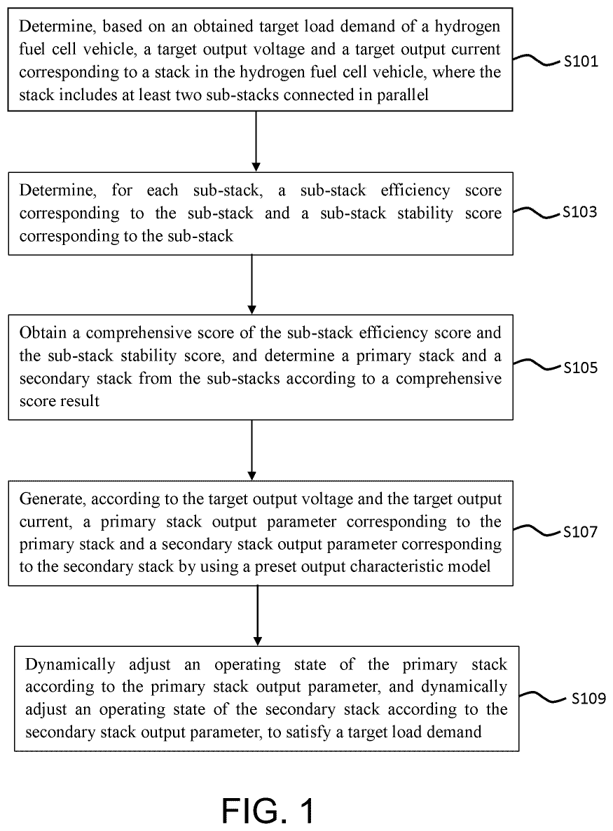

A coordinated optimization method for a hydrogen fuel cell vehicle is provided in this embodiment. FIG. 1 is a flowchart of a coordinated optimization method for a hydrogen fuel cell vehicle according to an embodiment of the present application. As shown in FIG. 1, the flow includes the following steps.

Step S101: Determine, based on an obtained target load demand of a hydrogen fuel cell vehicle, a target output voltage and a target output current corresponding to a stack in the hydrogen fuel cell vehicle, where the stack includes at least two sub-stacks connected in parallel.

Specifically, to accurately determine a load power demand required by a motor when the hydrogen fuel cell vehicle supplies external power, it is first necessary to select a high-precision sensor to obtain load data of the motor in real time. Since the sensor data may be disturbed by noise, it is necessary to perform noise filtering and filtering on these data in subsequent processing, to eliminate unnecessary high-frequency interference. Then, outliers in the data are identified and processed by outlier detection, to ensure the accuracy and reliability of the data. Finally, the consistency of the data is validated by data verification, so as to obtain an accurate target load demand. This series of preprocessing steps ensures the accuracy and availability of final load power demand data, thereby obtaining the target load demand.

According to the target load demand, the stack of the hydrogen fuel cell vehicle needs to meet a specific output voltage and output current to satisfy a power supply demand. Accordingly, a fuzzy rule library may be constructed for implementation. Based on expert experience and historical operation data, the fuzzy rule library establishes a mapping relationship between the target load demand and the target output voltage and current of the stack. In this fuzzy rule library, an input variable is the target load demand, while an output variable is the target output voltage and current of the stack. Through this rule library, the output of the stack can be dynamically adjusted according to a real-time changing load demand, thereby satisfying power demands of the hydrogen fuel cell vehicle under different situations. This method ensures that the stack can flexibly adapt to various load conditions and optimize the performance of the hydrogen fuel cell vehicle.

Step S103: Determine, for each sub-stack, a sub-stack efficiency score corresponding to the sub-stack and a sub-stack stability score corresponding to the sub-stack.

The sub-stack efficiency score is configured for representing a ratio of an average output power of the sub-stack to an average input power over a specific period of time, to reflect the energy conversion efficiency of the sub-stack. The sub-stack stability score is configured for representing a degree of fluctuation of an output voltage and an output current of the sub-stack over a specific period of time, to reflect the operating stability of the sub-stack. The main purpose of determining the sub-stack efficiency score and the sub-stack stability score is to accurately evaluate the performance of the stack for effective stack management, control, and optimization. For example, if a sub-stack has a low sub-stack efficiency score or sub-stack stability score, the sub-stack may need to be optimized or replaced to ensure the performance and reliability of the entire stack. In addition, these scores may be further configured for adjusting operating conditions of the stack, such as gas flow, pressure, and temperature, to achieve a better performance and longer service life.

Specifically, parameters during the operation of the sub-stack, such as a hydrogen flow, an oxygen flow, an output current, an output voltage, a temperature, and a relative humidity, may be obtained. The sub-stack efficiency score and the sub-stack stability score corresponding to the sub-stack may be predicted by using a machine learning model. For example, to determine the sub-stack efficiency score and the sub-stack stability score, parameter data under different operating states, such as a hydrogen flow, an oxygen flow, an output current, a voltage, a temperature, and a relative humidity, need to be collected first. Next, missing values, outliers, and noise in the data are processed, and the data is normalized or standardized. By extracting time series features and applying models such as linear regression, support vector regression (SVR), random forest regression, or gradient boosted regression, the data set is divided into a training set and a test set. Model hyper-parameters are optimized by using a cross-validation technology, and the generalization ability is improved. When evaluating model performance in the training and validation stages, an efficiency score model is evaluated by using indexes such as a mean square error (MSE), a root mean square error (RMSE), and similar regression indexes or classification accuracy, F1 scores are adopted for a stability score model. Finally, by obtaining the parameter data in real time, the sub-stack efficiency score and the sub-stack stability score are determined by using the trained models.

Step S105: Obtain a comprehensive score of the sub-stack efficiency score and the sub-stack stability score, and determine a primary stack and a secondary stack from the sub-stacks according to a comprehensive score result.

The comprehensive score is configured for representing the advantages and disadvantages of evaluating and sorting the sub-stacks by weighting the sub-stack efficiency score and the sub-stack stability score, to reflect the overall performance of the sub-stack.

Specifically, the comprehensive score is obtained from the sub-stack efficiency score and the sub-stack stability score, different weights may be assigned, and a weighted average is calculated to evaluate the overall performance of the sub-stack. According to the comprehensive score result, the sub-stacks may be sorted and classified, and a primary stack and a secondary stack may be distinguished. The primary stack typically refers to a stack that undertakes a main energy conversion task in the stack and needs to have high efficiency and stability. The secondary stack may assume an auxiliary or standby role, and has performance requirements slightly lower than those of the primary stack. For example, to evaluate the comprehensive score of each sub-stack, a weight of 0.6 for the sub-stack efficiency score and a weight of 0.4 for the sub-stack stability score may be assigned to calculate the comprehensive score of each sub-stack. Then, the sub-stacks are grouped by using a clustering algorithm such as K-means or hierarchical clustering, and stack clusters with similar performances are identified. Within each cluster, an overall performance of the cluster is summarized by calculating representative features such as an average comprehensive score and performance stability of the sub-stacks in the cluster. Then, based on these representative features, a stack feature set of each cluster is determined. To be specific, a stack feature set that best matches the performance features of the cluster is selected. A risk factor of each stack feature set is evaluated, and factors such as long-term stability and fault risk are considered. By screening a candidate stack feature set with the smallest risk factor, the best performance or the lowest risk is ensured. Finally, the comprehensive scores of the sub-stacks are sorted in descending order in the screened candidate stack feature set. A sub-stack corresponding to the highest comprehensive score is selected as the primary stack, and the remaining sub-stack serves as the secondary stack.

Step S107: Generate, according to the target output voltage and the target output current, a primary stack output parameter corresponding to the primary stack and a secondary stack output parameter corresponding to the secondary stack by using a preset output characteristic model.

Specifically, output parameters of the stack are generated by using the preset output characteristic model according to the target output voltage and the target output current as a reference for operating the sub-stack. Based on the operating characteristics and performance data of the stack, the model simulates stack behaviors under different current and voltage conditions. The model calculates output parameters of the primary stack under these conditions, such as a corresponding output voltage, output current, and output power, and obtains a theoretical expected performance. Similarly, the model also generates output parameters of the secondary stack, which may reflect a lower power output because the secondary stack performs slightly less than the primary stack. The primary stack is responsible for providing a main power output. The secondary stack may perform auxiliary adjustment according to the status of the primary stack to balance an overall load of the hydrogen fuel cell vehicle, thereby avoiding overload or inefficient operation of the primary stack.

To construct a model, performance data of the primary stack and the secondary stack under different voltage and current conditions, including current-voltage characteristics, power output, efficiency, and stack design parameters, needs to be collected. The model is constructed by using a polynomial regression model, a neural network model, or empirical data, and historical data (such as a target output voltage, a target output current, and known design parameters) are input into the model, thereby generating the output parameters of the primary stack and the secondary stack. Subsequently, the parameters generated by the model are compared with actual measurement results to validate the accuracy of the model, and the model parameters are adjusted according to actual performance data to improve the prediction accuracy. Finally, the output parameters of the primary stack and the secondary stack are obtained by using the trained model in real time.

Step S109: Dynamically adjust an operating state of the primary stack according to the primary stack output parameter, and dynamically adjust an operating state of the secondary stack according to the secondary stack output parameter, to satisfy a target load demand.

Specifically, a flow, pressure, and temperature of hydrogen, a flow, pressure, and temperature of oxygen, and a flow, pressure, and temperature of water of the primary stack are dynamically adjusted according to the output parameters of the primary stack. A flow, pressure, and temperature of hydrogen, a flow, pressure, and temperature of oxygen, and a flow, pressure, and temperature of water of the secondary stack are dynamically adjusted according to the output parameters of the secondary stack, to satisfy the target load demand. For example, the flows, pressures, or temperatures of hydrogen, oxygen, and water are increased to improve the reaction rate, thereby increasing the output current and voltage. During the adjustment, an actual output voltage, an actual output current, and an actual output power must be monitored in real time to meet the output parameters of the primary stack or the secondary stack, thereby ensuring that the adjusted parameters can satisfy the target load demand. By adjusting the flows, pressures, and temperatures of the primary stack and the secondary stack separately, the reaction rate may be optimized, thereby improving the output efficiency of the entire hydrogen fuel cell vehicle. The primary stack may focus on providing an efficient output, while the secondary stack may assist in maintaining stable operating conditions.

According to the coordinated optimization method for a hydrogen fuel cell vehicle provided in this embodiment, the target output voltage and the target output current of the stack are determined based on the obtained target load demand, so that the stack can be dynamically adjusted according to a real-time load demand. This adjustment may optimize power outputs of the stack under different operating conditions, thereby improving the overall performance and efficiency of the hydrogen fuel cell vehicle. Then, the stack includes at least two sub-stacks connected in parallel, and the performance of each sub-stack may be accurately evaluated by determining efficiency scores and stability scores of the sub-stacks. It is beneficial to identify lower-performance sub-stacks and optimize or replace the sub-stacks, thereby ensuring the reliability and stability of the entire stack. Then, roles of the primary stack and the secondary stack are determined by the comprehensive score, which is beneficial to allocate resources to a stack with optimal performance. The primary stack undertakes a main energy conversion task, while the secondary stack serves as an auxiliary or standby stack. This allocation improves the overall efficiency and reliability of the hydrogen fuel cell vehicle. Based on the output parameters of the primary stack and the secondary stack generated by the preset output characteristic model, the operating state may be accurately adjusted to ensure that the output of the stack meets the target load demand, and dynamic response capability and operating efficiency are improved, thereby improving the overall performance of the hydrogen fuel cell vehicle.

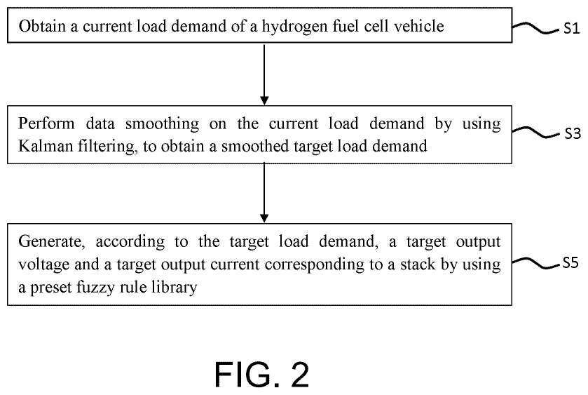

FIG. 2 is a flowchart of step S101 according to an embodiment of the present application. The flow may include the following steps.

Step S1: Obtain a current load demand of a hydrogen fuel cell vehicle.

Specifically, to ensure the accuracy of data, a load demand of the hydrogen fuel cell vehicle may be obtained in real time by using a high-precision sensor. First, power is obtained by measuring a voltage and a current flowing through a stack and calculating a product of the voltage and the current. Second, an operating condition of the vehicle and a load power required by an external power supply motor are obtained. In addition, it is also necessary to consider the power consumption of an air compressor, a water pump, and other devices in the vehicle. Finally, all load power demands are added to obtain a real-time current load demand.

Step S3: Perform data smoothing on the current load demand by using Kalman filtering, to obtain a smoothed target load demand.

Specifically, since sensor data may be disturbed by noise, it is necessary to perform noise filtering and filtering on these data in subsequent processing, to eliminate unnecessary high-frequency interference. For example, data smoothing is performed on the current load demand by using Kalman filtering. It is assumed that dynamics of a current load power demand at each time step k are described by the following linear state equation: xₖ=xₖ₋₁+wₖ, where xₖ is a load demand at a k^{th} step, and wₖ is a process noise. An observation model is constructed: zₖ=xₖ+vₖ, where zₖ is an observed load demand, and vₖ is an observation noise. An initial state is estimated. When the time step satisfies k=0, an initial estimate is \hat{x}₀, and an initial estimate error covariance is P₀. For each time step k, a current state is predicted first as

$${\hat{x}}_{k}^{-} = {\hat{x}}_{k - 1} ,$$

and the error covariance is predicted as

$${P}_{k}^{-} = {P}_{k - 1} + Q ,$$

where Q is the covariance of the process noise. Then, a state estimate is updated according to the observation data zₖ, and a Kalman gain is calculated as

$${K}_{k} = {P}_{k}^{-} / ( {P}_{k}^{-} + R ) ,$$

where R is the covariance of the observation noise, the estimated state is updated as

$${\hat{x}}_{k} = {\hat{x}}_{k}^{-} + {K}_{k} ( {z}_{k} - {\hat{x}}_{k}^{-} ) ,$$

and the error covariance is updated as

$${P}_{k} = ( 1 - {K}_{k} ) {P}_{k}^{-} .$$

An obtained load demand sequence [100, 105, 110, 500, 115] is taken as an example, where 500 may be caused by some anomaly. Assuming that the initial estimate \hat{x}₀ is a first observation value 100, a relatively large value, such as 1000, is typically selected for the initial estimate error covariance P₀. The covariance Q of the process noise is a smaller constant, such as 10. The covariance R of the observation noise is assumed to be a smaller constant, such as 5. Data smoothing is performed by using Kalman filtering, and data [100, 104, 108, 110, 113] is output, thereby eliminating the impact of outlier 500, which makes the whole data more stable and reasonable.

Step S5: Generate, according to the target load demand, a target output voltage and a target output current corresponding to a stack by using a preset fuzzy rule library.

Specifically, the target output voltage and current of the stack are determined by using the preset fuzzy rule library. The rule library is a set of predefined rules. Each rule corresponds to different input conditions and output decisions.

It is assumed that there are the following fuzzy rule libraries:
Rule1: If the load power is “low”, the target output voltage of the stack is “42 V” and the target current is “2 A”.
Rule2: If the load power is “medium”, the target output voltage of the stack is “48 V” and the target current is “3 A”.
Rule3: If the load power is “high”, the target output voltage of the stack is “54 V” and the target current is “4 A”.

The preprocessed target load power (for example, 110 W) is first fuzzed to “medium”. Then, according to Rule2, it may be determined that the target output voltage of the stack is 48 V and the target output current is 3 A.

Compared with the embodiment shown in FIG. 1, in this embodiment, the current load demand is obtained, and load demand data may be effectively smoothed by using Kalman filtering, thereby eliminating the impact of noise and outliers. Therefore, a data sequence is more stable and reasonable. This processing can improve the reliability of data, thereby improving the accuracy of the response of the stack to load changes. Then, by using the preset fuzzy rule library, the target output voltage and target output current of the stack are generated according to the smoothed target load demand. Therefore, the output of the stack can be optimized under various load conditions, thereby ensuring the performance and efficiency of the hydrogen fuel cell vehicle.

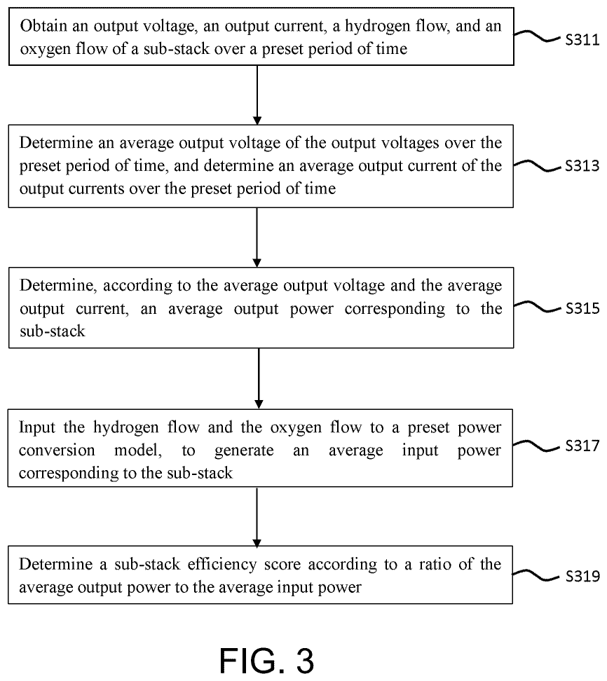

FIG. 3 is a flowchart of determining a sub-stack efficiency score corresponding to a sub-stack in step S103 according to an embodiment of the present application. The flow may include the following steps.

Step S311: Obtain an output voltage, an output current, a hydrogen flow, and an oxygen flow of a sub-stack over a preset period of time.

Specifically, the output voltage and the output current of the sub-stack are directly measured by using high-precision voltage and current sensors. These sensors are typically connected to a battery management system (BMS) to monitor electrical parameters of the sub-stack in real time. Over a preset period of time, output voltage data and output current data acquired by the sensors are recorded. A data acquisition system (such as a data recorder or an embedded system) may be disposed to periodically read and store the data. The flows of hydrogen and oxygen are measured by using, for example, a mass flow meter or a volumetric flow meter. The hydrogen flow is typically measured in standard liters per minute (SLM) or liters per hour (L/h). The oxygen flow is likewise measured in SLM or L/h. The flow meters typically provide real-time flow data. The data may be transmitted to the BMS through an electronic interface (such as an analog signal, a digital signal, or a communication bus). Over a preset period of time, flow data of hydrogen and flow data of oxygen are recorded. Meanwhile, it is ensured that the data acquisition time of all the sensors and the flow meters is synchronized to facilitate subsequent data analysis. For example, acquisition time of each data point is recorded by using timestamps, to ensure the time consistency of different types of data.

Step S313: Determine an average output voltage of the output voltages over the preset period of time, and determine an average output current of the output currents over the preset period of time.

Specifically, data points of the output voltages and the output currents are recorded over a preset period of time. For example, voltage and current are recorded every second. All the recorded voltage values are added over a preset period of time and then divided by a total number of records to obtain the average output voltage. All the recorded current values are added over a preset period of time and then divided by a total number of records to obtain the average output current.

Step S315: Determine, according to the average output voltage and the average output current, an average output power corresponding to the sub-stack.

Specifically, the corresponding average output power is obtained by multiplying the average output voltage and the average output current.

Step S317: Input the hydrogen flow and the oxygen flow to a preset power conversion model, to generate an average input power corresponding to the sub-stack.

Specifically, the power conversion model is trained according to collected historical data, including a hydrogen flow, an oxygen flow, a corresponding stack average output power, and other related parameters (such as a stack operating temperature and pressure). The collected data is preprocessed, including washing (removing outliers and missing values), standardization or normalization (providing the data with a uniform proportion and range). The power conversion model is trained based on features and targets (input power) by using an appropriate algorithm (such as regression analysis, a neural network, or a support vector machine). The accuracy and generalization ability of the power conversion model are validated by cross-validation and test set evaluation. The trained power conversion model is configured for real-time data prediction. A real-time hydrogen flow and oxygen flow are input, and the power conversion model will generate the corresponding average input power.

Step S319: Determine a sub-stack efficiency score according to a ratio of the average output power to the average input power.

Specifically, an efficiency score is calculated by dividing the average output power by the average input power and is converted into a corresponding score. For example, the average input power is 15000 watts, and the average output power is 12000 watts. The efficiency is typically represented by a percentage. Therefore, a ratio is multiplied by 100 to obtain a percentage form of the efficiency. The calculated efficiency percentage may be directly used as the sub-stack efficiency score. Therefore, the sub-stack efficiency score is 80.

Compared with the embodiment shown in FIG. 1, in this embodiment, the output voltage, the output current, the hydrogen flow, and the oxygen flow of the sub-stack are obtained over a preset period of time, and an average value of the output voltage and the output current is calculated, so that the impact on momentary fluctuation can be reduced, evaluated voltage and current values are more representative, and the actual performance of the sub-stack can be better reflected. The average output power calculated based on accurate voltage and current data provides necessary data for performance evaluation of the sub-stack. By inputting hydrogen and oxygen flow data into the power conversion model, an energy demand of the sub-stack may be effectively estimated, thereby evaluating the energy efficiency and operating state thereof. Finally, by calculating a ratio of the output power to the input power, the efficiency of the sub-stack may be accurately evaluated. The efficiency score intuitively reflects an energy efficiency level of the sub-stack and helps to optimize the performance and energy utilization efficiency thereof.

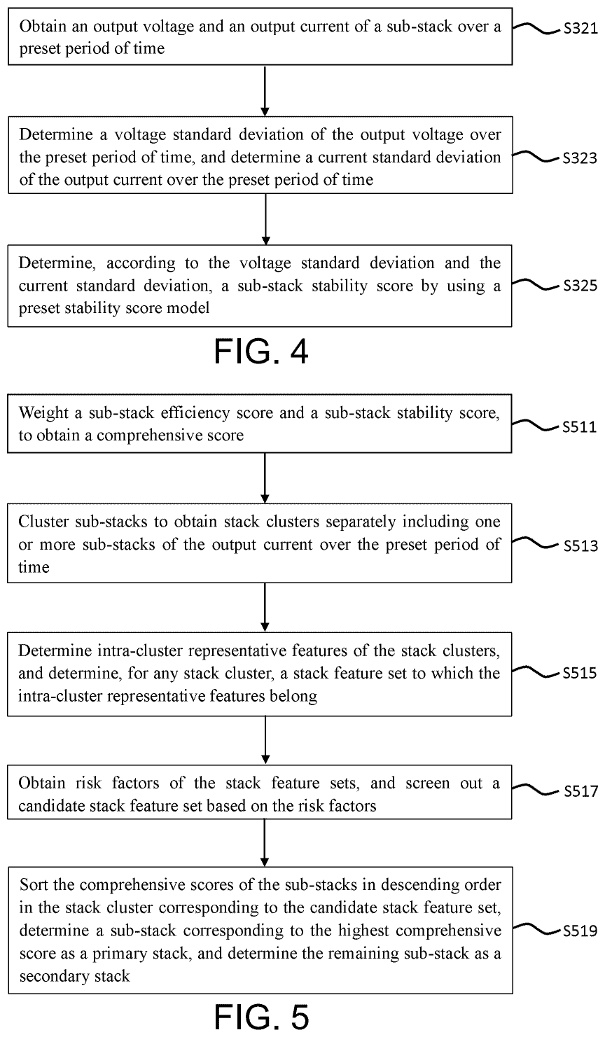

FIG. 4 is a flowchart of determining a sub-stack stability score corresponding to a sub-stack in step S103 according to an embodiment of the present application. The flow may include the following steps.

Step S321: Obtain an output voltage and an output current of a sub-stack over a preset period of time.

Specifically, the output voltage and the output current of the sub-stack are directly measured by using high-precision voltage and current sensors. These sensors are typically connected to a BMS to monitor electrical parameters of the stack in real time. Over a preset period of time, output voltage data and output current data acquired by the sensors are recorded. A data acquisition system (such as a data recorder or an embedded system) may be disposed to periodically read and store the data. Meanwhile, it is ensured that the acquisition time of all the sensors is synchronized to facilitate subsequent data analysis. For example, acquisition time of each data point is recorded by using timestamps, to ensure the time consistency of different types of data.

Step S323: Determine a voltage standard deviation of the output voltage over the preset period of time, and determine a current standard deviation of the output current over the preset period of time.

Specifically, a standard deviation is a statistical index for measuring data fluctuation and is configured for describing how dispersed data points are relative to a mean thereof. A smaller standard deviation indicates that the data points are more concentrated near the mean. A larger standard deviation indicates that the distribution of the data points is more scattered. Over a preset period of time, a mean (i.e., an average value) of the output voltage or the output current is first calculated. For each data point, a difference (deviation) from the mean is calculated. Each deviation value is squared to obtain a squared deviation. All the squared deviations are averaged to obtain a variance. The standard deviation is a square root of the variance. The voltage standard deviation and the current standard deviation may reflect the output stability of the sub-stack during operation. If the standard deviation is small, the voltage and the current are relatively stable. A larger standard deviation indicates large voltage and current fluctuations, which may affect the performance or safety of the sub-stack.

Step S325: Determine, according to the voltage standard deviation and the current standard deviation, a sub-stack stability score by using a preset stability score model.

Specifically, the preset stability score model may be expressed as a stability score formula:

Sub-stack stability score=100−(voltage standard deviation+current standard deviation)

Assuming that the calculated voltage standard deviation is 2 volts and the current standard deviation is 3 amps, the sub-stack stability score is 95 by substituting the formula. To be specific, the sub-stack stability is very high. Because the score is close to 100, it indicates that voltage and current fluctuations are very small. A lower standard deviation value results in a score close to 100, reflecting the stability of the sub-stack.

Compared with the embodiment shown in FIG. 1, in this embodiment, the output voltage and the output current of the sub-stack over a preset period of time are obtained, and the stability is measured by calculating a standard deviation of voltage and current. The standard deviation reflects the fluctuation of data, so as to evaluate the performance of the sub-stack. The standard deviation is converted into a stability score, which makes the stability evaluation of the cell more intuitive and quantitative, and is convenient for comparison and decision.

FIG. 5 is a flowchart of step S105 according to an embodiment of the present application. The flow may include the following steps.

Step S511: Weight a sub-stack efficiency score and a sub-stack stability score, to obtain a comprehensive score.

Specifically, different weights may be assigned to the sub-stack efficiency score and the sub-stack stability score. Then, weighted summation may be performed to obtain the corresponding comprehensive score. For example, given weights of the sub-stack efficiency score and the sub-stack stability score are 0.6 and 0.4, respectively. This means that the sub-stack efficiency score accounts for a larger proportion in the comprehensive score. The two weighted values are added together to obtain the comprehensive score: Comprehensive score=(80×0.6)+(95×0.4)=86. This comprehensive score not only reflects a single index of the sub-stack, but also comprehensively considers the performance of different dimensions, thereby providing a more comprehensive performance evaluation.

Step S513: Cluster sub-stacks to obtain stack clusters separately including one or more sub-stacks.

Specifically, performance data on the sub-stacks, including but not limited to a sub-stack efficiency score, a sub-stack stability score, an output voltage, an output current, a hydrogen flow, an oxygen flow, a current density, a mass/volume power density (measuring power generated per unit mass or unit volume of a stack, reflecting the energy conversion compactness of the stack), a fuel utilization (measuring a ratio of hydrogen efficiently converted into electric energy), an operating life, and gas permeability (sealing performance of a bipolar plate material in the stack to hydrogen or oxygen), needs to be collected first. Then, according to the characteristics of the data and clustering objectives, clustering analysis is performed on the sub-stacks by using a clustering algorithm including but not limited to K-means, hierarchical clustering, DBSCAN, spectral clustering, Gaussian mixture models, fuzzy C-means, K-medoids, MeanShift, OPTICS, and BIRCH, and the sub-stacks are assigned to different clusters to obtain stack clusters separately including one or more sub-stacks.

Step S515: Determine intra-cluster representative features of the stack clusters, and determine, for any stack cluster, a stack feature set to which the intra-cluster representative features belong.

Specifically, once clustering results are obtained, it is next necessary to determine intra-cluster representative features of each stack cluster. A feature selection technology (such as principal component analysis (PCA) or feature importance ranking) may be used to evaluate which features are most important for the discrimination of clusters. For example, by using PCA, these features may be converted into a new, orthogonal set of principal components, which are arranged in descending order in terms of variance contribution. In this way, most of the information in the original data set may be approximately represented with fewer principal components. Meanwhile, the complexity of the data can be reduced, and the efficiency of analysis can be improved, so as to determine the intra-cluster representative features that can best represent the stack cluster. These intra-cluster representative features may be classified according to corresponding characteristics or attributes, to obtain the stack feature set to which the intra-cluster representative features belong.

Step S517: Obtain risk factors of the stack feature sets, and screen out a candidate stack feature set based on the risk factors.

Specifically, the risk factor is calculated for each stack feature set. The risk factor corresponding to the stack feature set may be predicted according to a preset machine learning model. Then, a candidate stack feature set with the lowest risk factor may be screened out by sorting in descending order of the risk factors.

Step S519: Sort the comprehensive scores of the sub-stacks in descending order in the stack cluster corresponding to the candidate stack feature set, determine a sub-stack corresponding to the highest comprehensive score as a primary stack, and determine the remaining sub-stack as a secondary stack.

Specifically, the comprehensive scores of all the sub-stacks are sorted in descending order in the stack cluster corresponding to the candidate stack feature set. A sub-stack corresponding to the highest comprehensive score is selected as a primary stack, and the remaining sub-stack is determined as a secondary stack. It is ensured that the primary stack and the secondary stack selected finally are representative and reliable.

For example, five sub-stacks are provided. Each sub-stack obtains performance parameters: output voltage (V), output current (A), hydrogen flow (SLM), oxygen flow (SLM), current density (mA/cm²), mass/volume power density (W/kg), fuel utilization (%), operating life (hour), and gas permeability (%). Then, the data is standardized, and K-means algorithm is selected for clustering to obtain three clusters. The features of each cluster are analyzed by using PCA. The original features are converted into several principal components. The intra-cluster representative features of each stack cluster are determined. For example, the first intra-cluster representative feature is the mass/volume power density and the operating life. The second intra-cluster representative feature is the oxygen flow and the hydrogen flow. The third intra-cluster representative feature is the operating life and the current density. The stack feature set to which the intra-cluster representative features belong is determined. For example, the stack feature set corresponding to the first stack cluster includes the mass/volume power density and the operating life. The stack feature set corresponding to the second stack cluster includes the oxygen flow and the hydrogen flow. The stack feature set corresponding to the third stack cluster includes the operating life and the current density. The risk of each stack feature set is predicted by constructing or using an existing machine learning model. A risk factor is calculated for the stack feature sets in each cluster. The stack feature set with the lowest risk factor is selected as a candidate stack feature set. Then, the comprehensive scores of the sub-stacks are sorted in descending order in the stack cluster corresponding to the candidate stack feature set, a sub-stack corresponding to the highest comprehensive score is determined as a primary stack, and the remaining sub-stack is determined as a secondary stack.

Compared with the embodiment shown in FIG. 1, in this embodiment, a comprehensive performance evaluation is provided by comprehensively considering the sub-stack efficiency score and the sub-stack stability score by a weighted summation method. This method can balance different performance indexes and ensure that a final score is more representative. Then, the sub-stacks are classified by using a clustering algorithm, so that the sub-stacks with similar performance can be classified into a same cluster, thereby simplifying subsequent analysis and decision processes. The intra-cluster representative features are determined, thereby effectively reducing the data complexity and improving the efficiency and accuracy of feature selection. By calculating and screening out the risk factors, it is ensured that the risk of the selected stack feature set is minimal, thereby enhancing the safety and reliability of stack selection. According to the comprehensive score and risk evaluation results, the sub-stack with the highest comprehensive score is selected as the primary stack, and the remaining sub-stack serves as the secondary stack. It is beneficial to optimize the configuration of the stack while ensuring the performance.

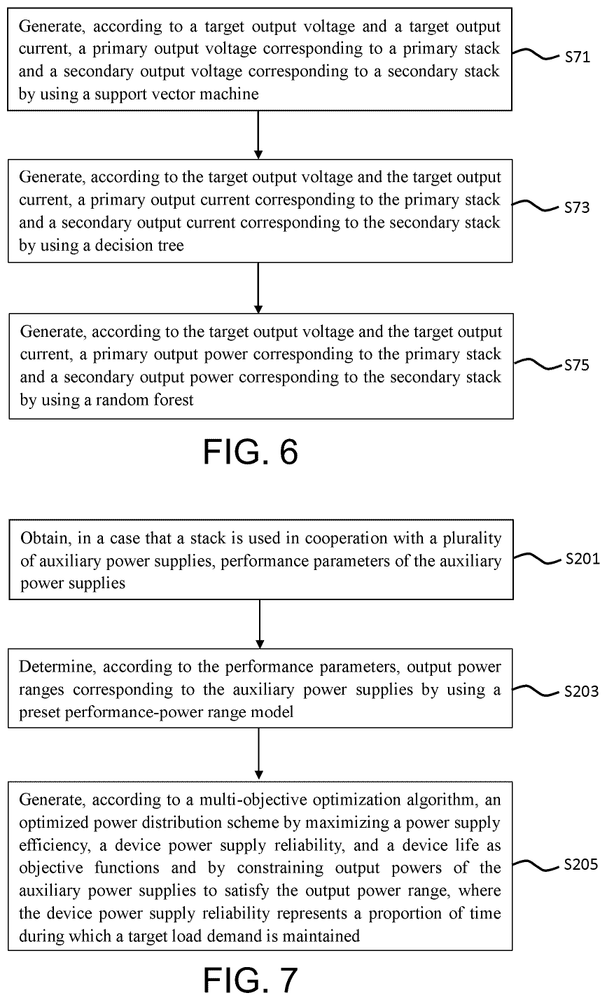

FIG. 6 is a flowchart of step S107 according to an embodiment of the present application. The preset output characteristic model includes a support vector machine, a decision tree, and a random forest. The primary stack output parameter includes a primary output voltage, a primary output current, and a primary output power. The secondary output parameter includes a secondary output voltage, a secondary output current, and a secondary output power. The flow may include the following steps.

Step S71: Generate, according to a target output voltage and a target output current, a primary output voltage corresponding to a primary stack and a secondary output voltage corresponding to a secondary stack by using a support vector machine.

Specifically, a support vector machine (SVM) serves as a supervised learning model for classification and regression analysis. The SVM is configured herein for predicting the primary output voltage of the primary stack and the secondary output voltage of the secondary stack, based on the target output voltage and the target output current. The SVM will be trained based on historical data (including the target output voltage, the target output current, performance parameters of the primary stack, and performance parameters of the secondary stack). During the training process, the model may learn a distribution relationship between output voltages and output currents corresponding to the primary stack and the sub-stacks, and generate the primary output voltage of the primary stack and the secondary output voltage of the secondary stack respectively through this relationship.

Step S73: Generate, according to the target output voltage and the target output current, a primary output current corresponding to the primary stack and a secondary output current corresponding to the secondary stack by using a decision tree.

Specifically, a training data set including the target output voltage, the target output current, the performance parameters of the primary stack, the performance parameters of the secondary stack, and a corresponding stack output current is first prepared. A decision tree model is trained by using the data. The model constructs a tree structure to capture a relationship between input and output by segmenting features in a data set (such as the target output voltage and current). The decision tree is split at each node according to some features (such as the target output voltage or current), and a decision path is gradually constructed. Through the path of the tree, the decision tree maps the input target output voltage and current to the primary output current of the primary stack and the secondary output current of the secondary stack. Through the decision tree, after inputting the target output voltage and the target output current, a primary output current predicted value of the primary stack and a secondary output current predicted value are obtained. Through an output current value generated by the decision tree, the working status of the primary stack and the secondary stack may be optimized to ensure that the hydrogen fuel cell vehicle can achieve an expected performance and stability under specified conditions. The primary output current corresponding to the primary stack may alternatively be generated by using a decision tree according to the target output voltage and the target output current. The secondary output current corresponding to the secondary stack may be generated by using another decision tree according to the target output voltage and the target output current.

Step S75: Generate, according to the target output voltage and the target output current, a primary output power corresponding to the primary stack and a secondary output power corresponding to the secondary stack by using a random forest.

Specifically, a data set including the target output voltage, the target output current, the performance parameters of the primary stack and the secondary stack, and the corresponding stack output current is collected. The data set should include output power values of the primary stack and the secondary stack. A random forest regression model is trained by using a training data set. The random forest model may create a plurality of decision trees. A final predicted value is obtained by averaging results of these trees.

Compared with the embodiment shown in FIG. 1, in this embodiment, the primary output voltage of the primary stack and the secondary output voltage of the secondary stack may be accurately predicted by using the support vector machine. The decision tree can generate the primary output current of the primary stack and the secondary output current of the secondary stack by analyzing the target output voltage and the target output current. The random forest can generate the primary output power of the primary stack and the secondary output power of the secondary stack by training a plurality of decision trees and integrating the results thereof. By using three different machine learning models, namely the support vector machine, the decision tree, and the random forest, the voltage, current, and power of the primary stack and the secondary stack in the hydrogen fuel cell vehicle can be comprehensively and accurately predicted. This method optimizes the performance of the stack according to the target output parameter in complex practical applications of the hydrogen fuel cell vehicle, and improves the overall efficiency and stability of the hydrogen fuel cell vehicle.

In some embodiments, after step S107, the flow may further include the following steps:
comparing the primary output voltage with the target output voltage, and re-adjusting, in a case that a difference in a comparison result exceeds a voltage deviation threshold, the operating state of the primary stack and the operating state of the secondary stack; and
comparing the primary output current with the target output current, and re-adjusting, in a case that a difference in a comparison result exceeds a current deviation threshold, the operating state of the primary stack and the operating state of the secondary stack.

Specifically, since the primary stack and the secondary stack are disposed in parallel, the primary output voltage and the secondary output voltage are actually the same. In addition, the primary stack is a main power source, while the secondary stack is configured for assisting the primary stack. This configuration allows energy to be supplemented by the secondary stack when the performance of the primary stack degrades or the load demand increases. Therefore, it is only necessary to monitor whether there is a deviation between the primary output voltage and the target output voltage. If the deviation exceeds a voltage deviation threshold and is preferably set to 2%, the operating state of the primary stack and the operating state of the secondary stack need to be re-adjusted, so that the deviation between the primary output voltage and the target output voltage is kept within the range of the voltage deviation threshold. Likewise, while the primary stack is a main current source, the current of the secondary stack will affect a total current. Therefore, if a deviation between the primary output current and the target output current exceeds a current deviation threshold and is preferably set to 2%, the corresponding adjustment is needed, so that the deviation between the primary output current and the target output current is kept within the range of the current deviation threshold. The adjustment may be performed simultaneously for the primary stack and the secondary stack. For example, if the output current needs to be increased, it may be necessary to increase the load of the primary stack or increase the output of the secondary stack, and vice versa. A final objective is to ensure that the primary stack and the secondary stack can stably provide the required voltage and current to satisfy a target load demand.

Compared with the embodiment shown in FIG. 1, in this embodiment, the primary output voltage and the primary output current of the primary stack are continuously monitored and adjusted when a deviation exceeds a set threshold, to ensure that the hydrogen fuel cell vehicle is always maintained within an expected performance range. In this way, fluctuations caused by the performance reduction of the primary stack or load changes can be effectively handled, thereby improving the overall operating stability and reliability of the hydrogen fuel cell vehicle. The coordinated operation of the primary stack and the secondary stack can be ensured, thereby optimizing the power output, ensuring that the target load demand is satisfied, and reducing a potential fault risk caused by the deviation.

FIG. 7 is a flowchart of cooperative use of auxiliary power supplies according to an embodiment of the present application. The flow may include the following steps.

Step S201: Obtain, in a case that a stack is used in cooperation with a plurality of auxiliary power supplies, performance parameters of the auxiliary power supplies.

The auxiliary power supplies include a generator, a solar panel, and a lithium-ion battery stack.

The performance parameters include a power generation efficiency of the generator, a maximum output power of the solar panel, and a capacity of the lithium-ion battery pack.

Specifically, the reliability and flexibility of a hydrogen fuel cell vehicle can be improved when used in cooperation with the auxiliary power supplies. The auxiliary power supplies supply standby power, ensuring that power can continue in the event of a main power fault. Meanwhile, according to the advantages and disadvantages of different power supplies, energy use may be optimized, thereby reducing operating costs, and improving the overall utilization efficiency of energy. By monitoring the power generation efficiency of a generator, an operating state may be dynamically adjusted to ensure that the generator operates at optimal efficiency, thereby reducing fuel consumption and operating costs. The maximum output power of the solar panel is known in real time, which facilitates optimization of the utilization of solar energy, adjusts load distribution, ensures maximum use of solar resources, and reduces dependence on other power supplies. The capacity of the lithium-ion battery stack is monitored, which facilitates management of a charge-discharge state of the battery and avoids over-discharge or overcharge, thereby prolonging battery life and ensuring that the battery can provide enough power when needed.

Step S203: Determine, according to the performance parameters, output power ranges corresponding to the auxiliary power supplies by using a preset performance-power range model.

Specifically, a mapping model is established to determine the output power range of each auxiliary power supply according to the performance parameters and the load demand. It is ensured that the hydrogen fuel cell vehicle can satisfy a real-time changing load demand while optimizing the usage efficiency of each auxiliary power supply.

For example, the power generation efficiency of the generator is obtained, for example, 90%. The maximum output power of the solar panel is obtained, for example, 100 kilowatts (kW). The capacity of the lithium-ion battery stack is obtained, for example, 200 kilowatt hours (kWh). Assuming that the current target load demand is 500 kW, the preset performance-power range model can determine an output power range of the generator to be 450 to 500 kW, an output power range of the lithium-ion battery stack to be 0 to 200 kW, and an output power range of the solar panel to be 0 to 100 kW.

Step S205: Generate, according to a multi-objective optimization algorithm, an optimized power distribution scheme by maximizing a power supply efficiency, a device power supply reliability, and a device life as objective functions and by constraining output powers of the auxiliary power supplies to satisfy the output power range, where the device power supply reliability represents a proportion of time during which a target load demand is maintained.

Power supply efficiency=input power/output power=(output power of generator, output power of solar panel, and output power of lithium-ion battery pack)/target load demand

Device power supply reliability=proportion of time during which an output power of a device can maintain a target load demand.

The effective use time of the device life (of the generator, the lithium-ion battery pack, or the solar panel) may typically be measured by the age limit of the device or the number of hours for operation.

The device power supply reliability may be obtained by recording the operating state and the output power of the auxiliary power supply over a period of time. A time window (for example, 1 hour, 1 day, or 1 week) is set. The performance of the auxiliary power supply is evaluated within the time window. It is possible to monitor and record whether the auxiliary power supply can continuously provide power required by the load within the time window. According to the obtained data, a machine model is trained, and the finally trained model can obtain a time proportion corresponding to the output power of the auxiliary power supply.

In some embodiments, the generating, according to a multi-objective optimization algorithm, an optimized power distribution scheme further includes satisfying the following conditions.

The target load demand is equal to a sum of the output powers of the stacks and the output powers of the auxiliary power supplies.

Specifically, the total output power (including the output powers of all the stacks and the auxiliary power supplies) is required be equal to the target load demand. This means that the combined output of all the power supplies is required to satisfy the power demand of the load.

The output power of each sub-stack is required to be within a design limit range.

Specifically, the output power of each sub-stack is required to be within the design limit range, to ensure that the stack is not damaged or less efficient due to overload.

In some embodiments, the objective function includes:

$$min {\sum }_{t = 1}^{24} [ {w}_{1} \times {a}_{i} + {w}_{2} \times {b}_{i} + {w}_{3} \times {c}_{i} ] ,$$

power supply efficiency=output power of stack or auxiliary power supply/target load demand,
where w₁, w₂, and w₃ are weight coefficients, αᵢ is the power supply efficiency of an i^{th} sub-stack or auxiliary power supply, bᵢ is the device power supply reliability of the i^{th} sub-stack or auxiliary power supply, and cᵢ is the device life of the i^{th} sub-stack or auxiliary power supply.

Specifically, a multi-objective optimization algorithm is used to search for an optimal power distribution scheme according to the objective function and constraints. From a plurality of solutions found by the multi-objective optimization algorithm, one solution that achieves the best balance among power supply efficiency, system reliability, and power supply life is selected.

Compared with the embodiment shown in FIG. 1, in this embodiment, by using the auxiliary power supplies (a generator, a solar panel, and a lithium-ion battery pack) in cooperation, even if a main power supply has a fault, the auxiliary power supplies can continue to supply power, and the normal operation of the hydrogen fuel cell vehicle is ensured. The power generation efficiency of the generator, the maximum output power of the solar panel, and the capacity of the lithium-ion battery pack are monitored in real time, and the output power ranges of the auxiliary power supplies are determined according to the performance parameters of the auxiliary power supplies through the preset performance-power range model, so as to ensure that the hydrogen fuel cell vehicle can satisfy the real-time changing load demand and optimize the use efficiency of each auxiliary power supply. The power distribution scheme is generated by using the multi-objective optimization algorithm, the power supply efficiency, the device power supply reliability, and the device life are comprehensively considered, the best balance point can be found therefrom, and the overall performance can be improved.

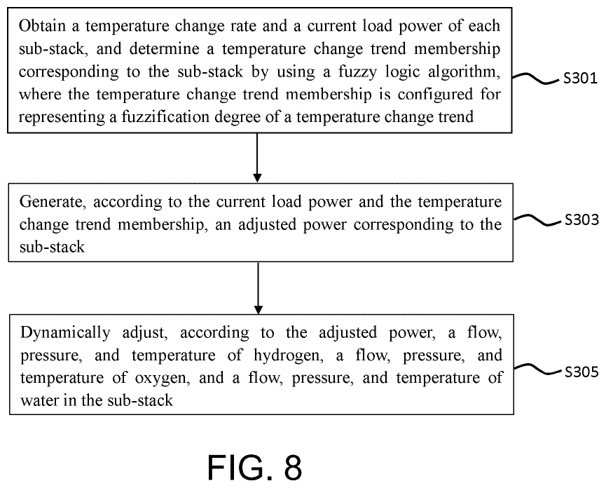

FIG. 8 is a flowchart of temperature change adjustment according to an embodiment of the present application. The flow may include the following steps.

Step S301: Obtain a temperature change rate and a current load power of each sub-stack, and determine a temperature change trend membership corresponding to the sub-stack by using a fuzzy logic algorithm, where the temperature change trend membership is configured for representing a fuzzification degree of a temperature change trend.

Specifically, the temperature change trend membership is configured for representing the fuzzification degree of the temperature change trend. An exact value is typically mapped into an interval [0, 1], where 0 indicates that the value does not belong entirely to a fuzzy set, and 1 indicates that the value belongs entirely to the fuzzy set. A value between 0 and 1 indicates a partial membership of the value to the fuzzy set. The temperature change rate and the current load power of each sub-stack are acquired in real time by sensors. Fuzzy sets and membership functions are defined for the temperature change rate and the load power. For example, the temperature change rate may be defined as “low”, “medium”, and “high”, and the membership functions are assigned to these sets. For example, the temperature change rate may be defined as a low temperature change rate (e.g. 0° C./min to 3° C./min), a medium temperature change rate (e.g. 3° C./min to 8° C./min), and a high temperature change rate (e.g. 8° C./min to 15° C./min). The load power may be defined as a low load power (e.g. 0 kW to 30 kW), a medium load power (e.g. 30 kW to 70 kW), and a high load power (e.g. 70 kW to 100 kW). In the fuzzy logic algorithm, a fuzzy rule library is constructed according to domain knowledge or expert experience, for example, Rule 1: If the temperature change rate is “medium” and the load power is “low load”, the temperature change trend is “low”. Rule 2: If the temperature change rate is “medium” and the load power is “medium load”, the temperature change trend is “medium”. Rule 3: If the temperature change rate is “medium” and the load power is “high load”, the temperature change trend is “high”.

For example, the obtained temperature change rate of the sub-stack is 6° C./min, and the current load power is 50 kW. The temperature change rate is between 3° C./min and 8° C./min, and the temperature change trend is considered to be “medium”. The corresponding membership function is:

$${μ}_{m e d i u m} ( x ) = \{ \begin{matrix}\frac{x - 3}{5} & if 3 < x \leq 8\end{matrix}$$

where x is the obtained temperature change rate. When the temperature change rate x is between 3° C./min and 8° C./min, the membership increases linearly from 0 to 1. Therefore, the membership value corresponding to 6° C./min is 0.6, indicating that the degree of membership of this temperature change rate in the “medium temperature change rate” fuzzy set is medium. This value reflects the membership of 6° C./min relative to the “medium” set, and may be used for subsequent fuzzy logic inference and decision-making.

If the load power is between 30 kW and 70 kW, the load power is considered to be “medium”. The corresponding membership function is:

$${μ}_{m e d i u m} ( P ) = \{ \begin{matrix}\frac{P - 30}{40} & if 30 < P \leq 70\end{matrix}$$

where P is the load power. Therefore, the membership value corresponding to 50 kW is 0.5, indicating that the degree of membership of this load power in the “medium load” fuzzy set is medium.

Finally, the results are aggregated and averaged, to obtain a temperature change trend membership corresponding to the sub-stack. Temperature change trend membership=(0.6+0.5)/2=0.55.

Step S303: Generate, according to the current load power and the temperature change trend membership, an adjusted power corresponding to the sub-stack.

Specifically, the load power and the temperature change rate are fuzzed into membership values. For example, the membership of the load power may be low (0.2), medium (0.5), or high (0.1). The membership of the temperature change rate may be low (0.3), medium (0.6), or high (0.1). The fuzzy membership values of the load power and the temperature change rate are transmitted into a trained neural network module as inputs. After processing these inputs, the neural network outputs a required heating power and cooling power. For example, the adjusted power corresponding to the sub-stack includes a heating power of 10 kW and a cooling power of 5 kW.

Step S305: Dynamically adjust, according to the adjusted power, a flow, pressure, and temperature of hydrogen, a flow, pressure, and temperature of oxygen, and a flow, pressure, and temperature of water in the sub-stack.

Specifically, hydrogen, oxygen, and water parameters are accurately adjusted by using, for example, a PID controller, according to the adjusted power. The flows, pressures, and temperatures of hydrogen, oxygen, and water are adjusted by using an actuator (e.g. a valve or a pump) according to the adjusted power. The operating state of the sub-stack is monitored in real time to ensure that the adjusted operating state can satisfy performance requirements. The monitored data is fed back to a control system to form a closed loop, and control parameters are dynamically adjusted according to a feedback signal.

For example, it is assumed that the heating power of 10 kW is required for the sub-stack to raise the temperature or maintain a specific temperature, while the cooling power of 5 kW is required to prevent overheating. According to the demand of increasing the flows of hydrogen and oxygen, more chemically reactive materials are provided, thereby improving the power output of the sub-stack. The pressure of the gas is adjusted to ensure that the gas distribution inside the sub-stack is uniform when the flow is increased. The temperature of the gas is adjusted as needed to optimize the rate of an electrochemical reaction. The flow of cooling water is adjusted to provide sufficient cooling capacity to absorb heat generated by the stack. The pressure of the water is adjusted to ensure that the cooling water can flow efficiently through a cooling channel of the stack. The temperature of the water is monitored to ensure that a suitable temperature range can be maintained as the water enters and exits the stack. This dynamic adjustment helps to improve the efficiency, stability, and life of the sub-stack.

It should be noted that the embodiments of steps S301 to S305 may be implemented after step S109. After the parameters of the primary stack and the secondary stack are adjusted, monitoring and adjustment are performed during the operation of the fuel cell vehicle, so that the efficiency, stability, and life of the sub-stack are further improved.

Compared with the embodiment shown in FIG. 1, in this embodiment, the temperature change rate and the load power of the sub-stack are obtained in real time by using the fuzzy logic algorithm, and are fuzzed into membership values, which can accurately reflect the actual operating state and temperature change trend of the sub-stack. Based on the fuzzy membership values and preset rules, an accurate adjusted power (including heating and cooling powers) is generated, to optimize the performance and stability of the sub-stack. The flows, pressures, and temperatures of hydrogen, oxygen and water are dynamically adjusted according to the adjusted power, to ensure that the sub-stack can maintain the optimal operating state under various load conditions, thereby improving the overall efficiency and prolonging the device life.

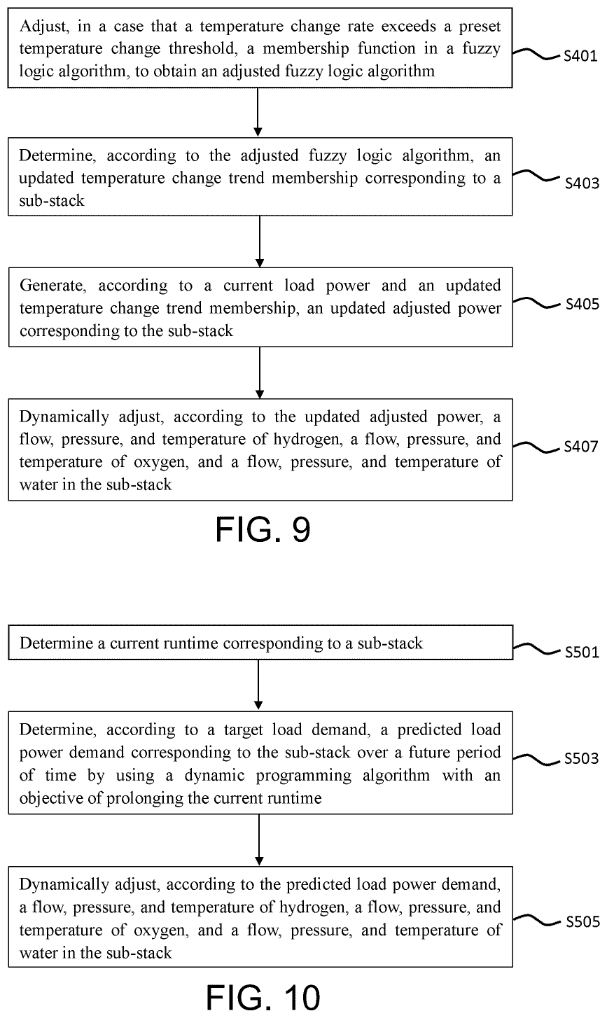

FIG. 9 is a flowchart of updated temperature change adjustment according to an embodiment of the present application. The flow may include the following steps.

Step S401: Adjust, in a case that a temperature change rate exceeds a preset temperature change threshold, a membership function in a fuzzy logic algorithm, to obtain an adjusted fuzzy logic algorithm.

Specifically, a temperature change rate threshold (e.g. 15° C./min) is set. If an actual temperature change rate exceeds this threshold, the membership function needs to be adjusted. In a case that the rate exceeds the threshold, the shape and range of the original membership function are adjusted. For example, if the membership function of the original temperature change rate is defined as “low”, “medium”, or “high”, the membership function may be extended or redefined to adapt to a new temperature change rate range. For a new membership function, a new fuzzy set, such as “very high”, may need to be added. A new membership function is defined for the new fuzzy set. For example, a low temperature change rate (0° C./min to 3° C./min), a medium temperature change rate (3° C./min to 8° C./min), a high temperature change rate (8° C./min to 15° C./min), and a very high temperature change rate (15° C./min and above) are included. The fuzzy logic rule library is updated according to the new membership function. For example, if the temperature change rate is “very high” and the load power is “high load”, a new fuzzy rule may need to be generated, to address the challenges posed by the high temperature change rate. The adjusted fuzzy logic algorithm is implemented, and the effects are validated by actual tests. It is ensured that the adjusted membership function and rule library can effectively cope with new temperature change conditions and optimize system performance.

Step S403: Determine, according to the adjusted fuzzy logic algorithm, an updated temperature change trend membership corresponding to a sub-stack.

Step S405: Generate, according to a current load power and an updated temperature change trend membership, an updated adjusted power corresponding to the sub-stack.

Step S407: Dynamically adjust, according to the updated adjusted power, a flow, pressure, and temperature of hydrogen, a flow, pressure, and temperature of oxygen, and a flow, pressure, and temperature of water in the sub-stack.

For the adjusted fuzzy logic algorithm, the implementations of steps S403 to S407 are consistent with those of steps S301 to S305, and will not be repeated herein. By continuously collecting data and training the neural network, optimal decisions can be made under various working conditions to ensure the safe and efficient operation of the sub-stack.

It should be noted that the embodiments of steps S401 to S407 may be implemented after step S109. After the parameters of the primary stack and the secondary stack are adjusted, monitoring and adjustment are performed during the operation of the fuel cell vehicle, so that the safe and efficient operation of the sub-stack is further ensured.

Compared with the embodiment shown in FIG. 1, in this embodiment, by adjusting the membership function in the fuzzy logic algorithm, it is possible to handle the situation that a preset temperature change rate threshold is exceeded. This adjustment aims to improve the adaptability of the algorithm and ensure that a more accurate control policy can be generated when the temperature change rate is high, thereby optimizing the operating effect of the sub-stack.

FIG. 10 is a flowchart of prolonging runtime according to an embodiment of the present application. The flow may include the following steps.

Step S501: Determine a current runtime corresponding to a sub-stack.

Specifically, a high-precision hydrogen sensor and measuring device, such as a gas flow meter, may be used to monitor a hydrogen flow in real time. An input amount and consumption amount of hydrogen are typically recorded to obtain a hydrogen inventory. A sub-stack efficiency may be calculated by measuring the amount of hydrogen input versus electric energy output by the sub-stack. A peak power demand refers to a maximum power required by the sub-stack at a maximum load. This may be determined by performance tests, where the sub-stack is operated under different load conditions until a maximum output power is reached. Required hydrogen=peak power demand/(sub-stack efficiency×33.333×10⁻⁶), where 33.333×10⁻⁶ is the conversion of a low calorific value of hydrogen (expressed in kilowatt hours per kilogram) into a unit that matches a power demand. Current runtime=current hydrogen inventory/required hydrogen amount.

Step S503: Determine, according to a target load demand, a predicted load power demand corresponding to the sub-stack over a future period of time by using a dynamic programming algorithm with an objective of prolonging the current runtime.

Specifically, modeling is performed by using the dynamic programming algorithm. State variables include a current hydrogen inventory, a current load power of the sub-stack, historical load data, and the like. The load power demand is required. To be specific, a load setting manner should be determined, to achieve an objective of prolonging the runtime over a future period of time. A main objective is to prolong the runtime of the sub-stack. The remaining constraints are that the output powers of all sub-stacks satisfy the target load demand and the sub-stacks satisfy design parameter requirements thereof. To be specific, after step S109, the parameters are continuously obtained, and the adjusted primary stack and secondary stack are further predicted to obtain respective predicted load demands. The predicted load demands are also corresponding output powers to be adjusted.

Step S505: Dynamically adjust, according to the predicted load power demand, a flow, pressure, and temperature of hydrogen, a flow, pressure, and temperature of oxygen, and a flow, pressure, and temperature of water in the sub-stack.

Specifically, according to the predicted load power demand obtained in the previous step, namely the output power of the sub-stack to be further adjusted, the flow, pressure, and temperature of hydrogen, the flow, pressure, and temperature of oxygen, and the flow, pressure, and temperature of water in the sub-stack are dynamically adjusted in the same manner as in step S305. Details are not described herein again.

It should be noted that the embodiments of steps S501 to S507 may be implemented after step S109. After the parameters of the primary stack and the secondary stack are adjusted, monitoring and adjustment are performed during the operation of the fuel cell vehicle, so that the operating performance of a hydrogen fuel cell is further optimized.

Compared with the embodiment shown in FIG. 1, in this embodiment, the current runtime of the sub-stack is accurately calculated. Then, the dynamic programming algorithm is used to predict a future load power demand according to the target load demand. By modeling the historical load data and the current hydrogen inventory, future load conditions can be predicted and optimized, to achieve an objective of prolonging the runtime of the sub-stack. This prediction can not only improve the operating efficiency of the stack, but also make adjustments when the load fluctuates, to ensure the stack stability. The flows, pressures, and temperatures of hydrogen, oxygen and water are dynamically adjusted according to the predicted load power demand. This dynamic adjustment can accurately match the output power demand of the sub-stack and optimize the operating performance of a hydrogen fuel cell. This adjustment manner can adapt to different load conditions, thereby improving the overall efficiency and stability of the hydrogen fuel cell vehicle.

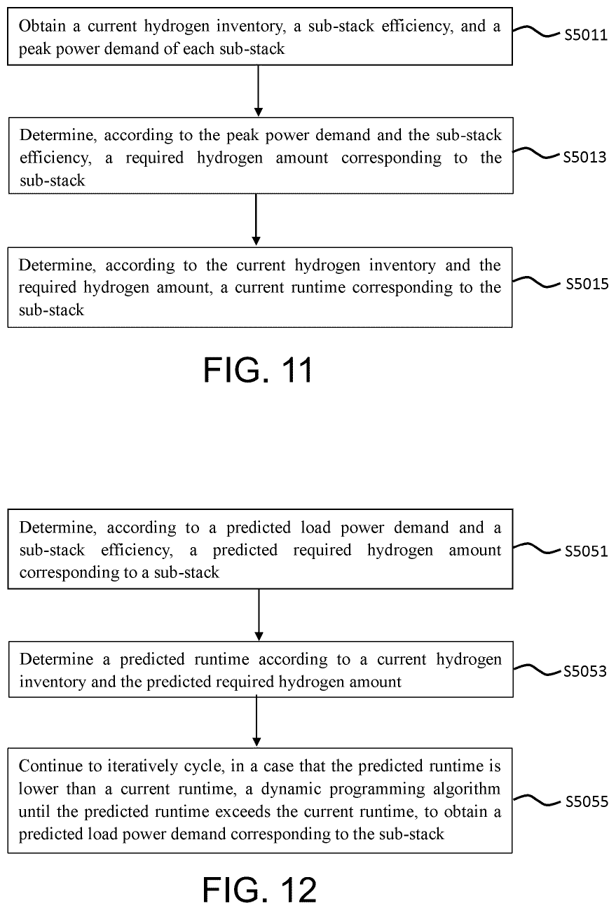

FIG. 11 is a flowchart of step S501 according to an embodiment of the present application. The flow may include the following steps.

Step S5011: Obtain a current hydrogen inventory, a sub-stack efficiency, and a peak power demand of each sub-stack.

Specifically, a high-precision hydrogen sensor and measuring device, such as a gas flow meter, may be used to monitor a hydrogen flow in real time. An input amount and consumption amount of hydrogen are typically recorded to obtain a hydrogen inventory. A sub-stack efficiency may be calculated by measuring the amount of hydrogen input versus electric energy output by the sub-stack. A peak power demand refers to a maximum power required by the sub-stack at a maximum load. This may be determined by performance tests, where the sub-stack is operated under different load conditions until a maximum output power is reached.

Step S5013: Determine, according to the peak power demand and the sub-stack efficiency, a required hydrogen amount corresponding to the sub-stack.

Specifically, required hydrogen=peak power demand/(sub-stack efficiency×33.333×10⁻⁶), where 33.333×10⁻⁶ is the conversion of a low calorific value of hydrogen (expressed in kilowatt hours per kilogram) into a unit that matches a power demand.

Step S5015: Determine, according to the current hydrogen inventory and the required hydrogen amount, a current runtime corresponding to the sub-stack.

Specifically, current runtime=current hydrogen inventory/required hydrogen amount.

Compared with the embodiment shown in FIG. 10, in this embodiment, by obtaining the current hydrogen inventory of the sub-stack, the sub-stack efficiency, and the peak power demand, the required hydrogen amount may be accurately calculated, thereby accurately determining a hydrogen demand of the sub-stack under various operating conditions. Further, according to a ratio of the current hydrogen inventory to the required hydrogen amount, the current runtime of the sub-stack can be estimated. This process provides an important basis for reasonable operation and maintenance planning.

FIG. 12 is a flowchart of a dynamic programming algorithm according to an embodiment of the present application. The flow may include the following steps.

Step S5051: Determine, according to a predicted load power demand and a sub-stack efficiency, a predicted required hydrogen amount corresponding to a sub-stack.

Specifically, predicted required hydrogen amount=predicted load power demand/sub-stack efficiency.

Step S5053: Determine a predicted runtime according to a current hydrogen inventory and the predicted required hydrogen amount.

Specifically, predicted runtime=current hydrogen inventory/predicted required hydrogen amount.

Step S5055: Continue to iteratively cycle, in a case that the predicted runtime is lower than a current runtime, a dynamic programming algorithm until the predicted runtime exceeds the current runtime, to obtain a predicted load power demand corresponding to the sub-stack.

Specifically, it is necessary to continue to iteratively cycle, in a case that the predicted runtime is lower than the current runtime, the dynamic programming algorithm until the predicted runtime exceeds the current runtime. This process enables the final predicted load power demand to accurately reflect an actual demand of the sub-stack.

Compared with the embodiment shown in FIG. 10, in this embodiment, in combination with the predicted load power demand and the sub-stack efficiency, the required hydrogen amount of the sub-stack under future load conditions can be accurately calculated. Then, by calculating the ratio of the current hydrogen inventory to the predicted required hydrogen amount, the predicted runtime of the sub-stack is accurately estimated. Finally, the dynamic programming algorithm is continuously iterated and optimized until the predicted runtime exceeds the current runtime, thereby ensuring the accuracy of the predicted load power demand.

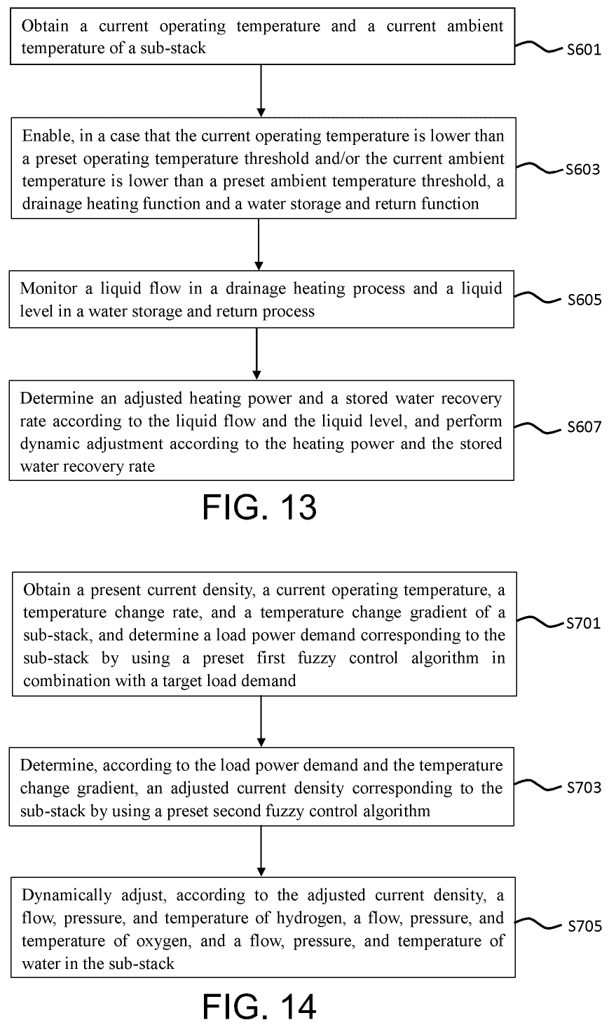

FIG. 13 is a flowchart of heating and water storage functions according to an embodiment of the present application. The flow may include the following steps.

Step S601: Obtain a current operating temperature and a current ambient temperature of a sub-stack.

Step S603: Enable, in a case that the current operating temperature is lower than a preset operating temperature threshold and/or the current ambient temperature is lower than a preset ambient temperature threshold, a drainage heating function and a water storage and return function.

Step S605: Monitor a liquid flow in a drainage heating process and a liquid level in a water storage and return process.

Step S607: Determine an adjusted heating power and a stored water recovery rate according to the liquid flow and the liquid level, and perform dynamic adjustment according to the heating power and the stored water recovery rate.

Specifically, in steps S601 to S607, the current operating temperature and the ambient temperature of the sub-stack are acquired in real time by using a sensor network. When the operating temperature is lower than a preset threshold (e.g. 2° C.) or when the ambient temperature is close to zero, the drainage heating function is enabled to prevent a drainage pipe from freezing. The water storage and return function is also enabled to ensure that water inside the stack will not freeze. The liquid flow in the drainage heating process and the liquid level in the water storage and return process are monitored by using a flow sensor and a liquid level sensor. The heating power and the stored water recovery rate are dynamically adjusted according to flow and liquid level data monitored in real time, to ensure that the stack operates in an optimal state. For example, if the liquid level is too high, the stored water recovery rate needs to be reduced to avoid excess water flowing back to the stack, which may lead to excessive humidity inside the stack. Conversely, if the liquid level is too low, the recovery rate can be increased to ensure that proper moisture is maintained inside the stack. If the flow is displayed to be too high, the drainage rate may need to be reduced to avoid excessive loss of moisture inside the stack. If the flow is too low, the flow may be increased to ensure that the water inside the stack is drained in time. Through the foregoing adjustment, it is possible to automatically respond to environmental changes and operating demands of the stack, ensuring that the stack operates in a safe and efficient state. This intelligent control policy helps to improve the performance and life of the stack while reducing maintenance costs.

It should be noted that the embodiments of steps S601 to S607 may be implemented after step S109. After the parameters of the primary stack and the secondary stack are adjusted, monitoring and adjustment are performed during the operation of the fuel cell vehicle, so that the performance and life of the stack are further improved.

Compared with the embodiment shown in FIG. 1, in this embodiment, the operating temperature and the ambient temperature are monitored in real time. When the temperatures are lower than the preset thresholds, the drainage heating function and the water storage and return function are automatically enabled, to effectively prevent water inside a drainage pipe and the stack from freezing, thereby protecting the stack from being affected by low temperature. The liquid flow and the liquid level are monitored in real time, and the heating power and the water return rate are dynamically adjusted according to actual data, thereby ensuring the normal operation of the stack, preventing excessive or insufficient moisture, and optimizing the internal humidity of the stack.

FIG. 14 is a flowchart of adjusting a current density according to an embodiment of the present application. The flow may include the following steps.

Step S701: Obtain a present current density, a current operating temperature, a temperature change rate, and a temperature change gradient of a sub-stack, and determine a load power demand corresponding to the sub-stack by using a preset first fuzzy control algorithm in combination with a target load demand.

Specifically, the present current density, the current operating temperature, the temperature change rate, and the temperature change gradient of the sub-stack are measured by using high-precision sensors, and fuzzy sets (e.g., “low”, “medium”, and “high”) are defined for the current density, the operating temperature, the temperature change rate, and the temperature change gradient. A membership function is created for each fuzzy set. Measured exact values are converted into fuzzy values, and memberships thereof in the respective fuzzy sets are calculated. Fuzzy control rules are defined according to the operation characteristics and performance requirements of the sub-stack. For example, the current density is low, medium, and high. The operating temperature is low, medium, and high. The temperature change rate is slow, medium, fast. The temperature change gradient is low, medium, and high. A membership function is created for each fuzzy set. The membership functions are configured for converting accurate numerical data into fuzzy values, typically in the form of triangular, trapezoidal, or Gaussian functions. For example, for a “high” set of current densities, a membership function above a threshold may be defined, where a portion above the threshold has a higher membership. Data measured in real time is converted into fuzzy values. Actual data is mapped into the fuzzy sets by using the defined membership functions, to obtain membership values of the current density, the temperature, the change rate, and the gradient. A first fuzzy control algorithm uses a fuzzy inference system (such as Mamdani or Sugeno inference) to process the fuzzy control rules and the fuzzy values to derive the load power demand. The inference system will calculate a fuzzy control output according to the weights and membership values of the rules. Fuzzy inference results are converted into actual load power demand values. This process is referred to as defuzzification, and clear output values may be obtained by using methods such as a centroid method. A final load power demand value is stored in a database, and a mapping relationship among the current density, the operating temperature, the temperature change rate, the temperature change gradient, and the load power demand is established, so as to facilitate the subsequent automatic adjustment and optimization.

Step S703: Determine, according to the load power demand and the temperature change gradient, an adjusted current density corresponding to the sub-stack by using a preset second fuzzy control algorithm.

Specifically, the load power demand, the temperature change gradient, and the adjusted current density are defined as fuzzy sets and membership functions. For example, the load power demand and the temperature change gradient may be defined as “low”, “medium”, and “high”. The current density may be defined as “low”, “medium”, “high”, and “very high”. A second fuzzy control algorithm may convert the actual measured load power demand and temperature change gradient into fuzzy values, and calculate memberships thereof in the respective fuzzy sets. If the temperature change gradient is “high”, the current density should be adjusted to “low”. If the load power demand is “high” and the temperature change gradient is “medium”, the current density should be adjusted to “medium”. The adjusted current density is determined by inference using fuzzy control rules and fuzzy data. Fuzzy inference results are converted into specific current density values. This is typically achieved by a defuzzification method such as a centroid method. The operating parameters of the stack are adjusted according to the defuzzified current density values. For example, a fuel supply amount or an air supply amount are adjusted to achieve a required current density.

For example, assuming that the load power demand of the sub-stack is 50 kW and the temperature change gradient is 3° C./cm, the temperature change gradient is considered to be “high” because a preset threshold of 2° C./cm is exceeded. According to the fuzzy control rules, the algorithm proposes to reduce the current density to 6 A/cm² to control a temperature rise rate within 3° C./s. The load power demand and the temperature change gradient are converted into fuzzy values. According to the fuzzy control rules, a specific adjusted current density is calculated, such as 6 A/cm².

Step S705: Dynamically adjust, according to the adjusted current density, a flow, pressure, and temperature of hydrogen, a flow, pressure, and temperature of oxygen, and a flow, pressure, and temperature of water in the sub-stack.

Specifically, a mathematical model may be established to describe the operating state of the stack, which typically includes the following portions. An electrochemical reaction model describes a process of generating water and electric energy through reaction of hydrogen and oxygen. A thermodynamic model considers the effect of temperature change of the stack on the reaction. A fluid dynamics model involves a relationship between gas flow, pressure, and flow velocity. Control policies are designed according to the established model, to adjust the flows, pressures, and temperatures of gas and liquid. These policies typically include feedback control and feedforward control. According to the feedback control, an actual current density and other performance parameters of the stack are monitored in real time, and the flows, pressures, and temperatures of hydrogen, oxygen, and water are adjusted, to keep the stack operating at an expected current density. According to the feedforward control, the parameters of gas and liquid are adjusted in advance based on the prediction of stack state changes, to prevent delay-induced performance fluctuations. Based on sensor data, a controller automatically adjusts the flows, pressures, and temperatures of gas and water to ensure that the stack meets a set current density under an optimized operating state. It may be the same as step S305. Details are not described herein again.

It should be noted that the embodiments of steps S701 to S705 may be implemented after step S109. After the parameters of the primary stack and the secondary stack are adjusted, monitoring and adjustment are performed during the operation of the fuel cell vehicle, so that the operating stability and efficiency of each sub-stack are further ensured.

Compared with the embodiment shown in FIG. 1, in this embodiment, the present current density, the current operating temperature, the temperature change rate, and the temperature change gradient of the sub-stack are obtained, and the data are processed by using the first fuzzy control algorithm. The operating state of the sub-stack can be accurately evaluated, and the load power demand can be predicted. Then, the second fuzzy control algorithm determines the adjusted current density according to the load power demand and the temperature change gradient. The current density can be dynamically adjusted during the operation of the sub-stack, to maintain the optimal operating state and efficiency of the stack. Finally, the flows, pressures, and temperatures of hydrogen, oxygen and water are dynamically adjusted according to the adjusted current density. The flows of gas and liquid in the sub-stack can be optimized in real time, to maintain the sub-stack under optimal operating conditions and ensure the operating stability and efficiency of the sub-stack, thereby improving the overall performance and responsiveness of the sub-stack.

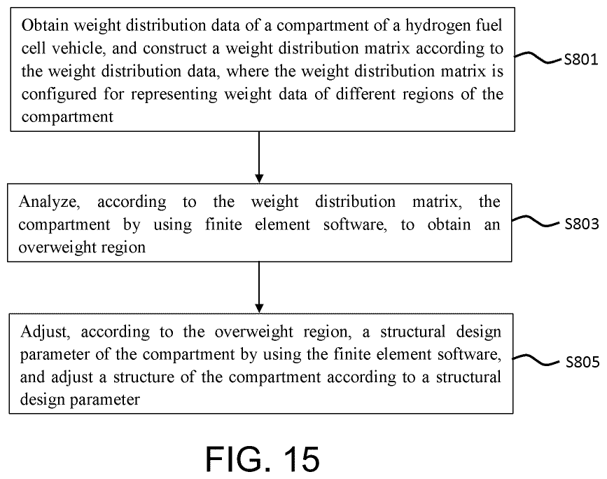

FIG. 15 is a flowchart of adjusting a weight distribution according to an embodiment of the present application. The flow may include the following steps.

Step S801: Obtain weight distribution data of a compartment of a hydrogen fuel cell vehicle, and construct a weight distribution matrix according to the weight distribution data, where the weight distribution matrix is configured for representing weight data of different regions of the compartment.

Specifically, since various devices such as a stack, a lithium-ion battery pack, various auxiliary power supplies, a cooling system, a heating system, an air conditioner, an air intake and exhaust device, and a centralized control cabinet are arranged on the hydrogen fuel cell vehicle, the stability of the hydrogen fuel cell vehicle is poor. For this reason, in this embodiment, a high-precision sensor is disposed in each square meter of the compartment, so as to ensure that the entire surface of the compartment is fully covered, and ensure that the sensor can accurately measure and record the weight where the sensor is located. The weight distribution data of the compartment is obtained in real time by using a sensor network, and the collected data may be preprocessed, including removing outliers, filtering, and calibrating, to ensure the accuracy of the data. The preprocessed data is constructed into a matrix according to the layout of the compartment. Each element in the matrix represents a weight of a corresponding region. For example, if the total area of the compartment is 20 square meters, the compartment may be divided into meshes of 3 rows and 6 columns. Each mesh corresponds to a position of a sensor. Then, the weight distribution matrix may be a 3×6 matrix.

Step S803: Analyze, according to the weight distribution matrix, the compartment by using finite element software, to obtain an overweight region.

Specifically, a geometric model of the compartment is constructed in the finite element software, to ensure that the size and shape of the model are consistent with those of an actual compartment. Corresponding physical and mechanical properties are assigned to a compartment material, such as density (e.g. 7800 kg/m³ steel), elastic modulus (e.g. 200 GPa steel), and Poisson's ratio (e.g. 0.3 steel). The geometric model is meshed to generate finite element meshes for analysis. The density of the meshes should be adjusted according to the accuracy requirements of the weight distribution. Data in the weight distribution matrix is converted into suitable load conditions (e.g. a distributed load or a concentrated load). Meanwhile, constraints under an actual operating state are simulated. Finite element analysis is performed, and the software will calculate and provide results of the stress, strain, displacement, and the like of the compartment. After the analysis is completed, the results are viewed and evaluated by using a post-processing tool of the finite element software, to obtain the overweight region.

Step S805: Adjust, according to the overweight region, a structural design parameter of the compartment by using the finite element software, and adjust a structure of the compartment according to a structural design parameter.

Specifically, a current load-bearing capacity of the overweight region is analyzed and compared with a designed load-bearing capacity, to determine whether design adjustments are needed. The structural design parameters to be adjusted, such as a material type, a thickness, a geometrical shape, or layout of reinforcing ribs, are determined. A parametric compartment model is created in the finite element software for quick adjustment and re-analysis of design parameters. According to the analysis results, the structural design parameters of the compartment are adjusted. For example, if a weight of a region is more than 600 kg, it may be necessary to increase the thickness of a material in the region or add reinforcing ribs.

It should be noted that the embodiments of steps S801 to S805 may be implemented before step S101, to ensure the reliability and durability of the compartment.

Compared with the embodiment shown in FIG. 1, in this embodiment, the weight distribution data of the compartment of the hydrogen fuel cell vehicle is obtained in real time, the weight distribution matrix is constructed according to the weight distribution data, and each element in the matrix represents the weight of the corresponding region. Then, the compartment is analyzed by using the finite element software, the overweight region of the compartment can be identified, the stress and bearing capacity of the compartment in actual use are evaluated, and a basis is provided for design optimization. The analysis results can reveal potential overweight regions, helping to discover and resolve structural problems in advance. According to the analysis results of the overweight region, the structural design parameter of the compartment, such as a material type, a thickness, or a geometrical shape, is adjusted. Through optimized design, the bearing capacity and stability of the compartment are enhanced, the load on the overweight region is reduced, and potential fault risks caused by insufficient design are reduced, thereby improving the reliability and durability of the overall structure.

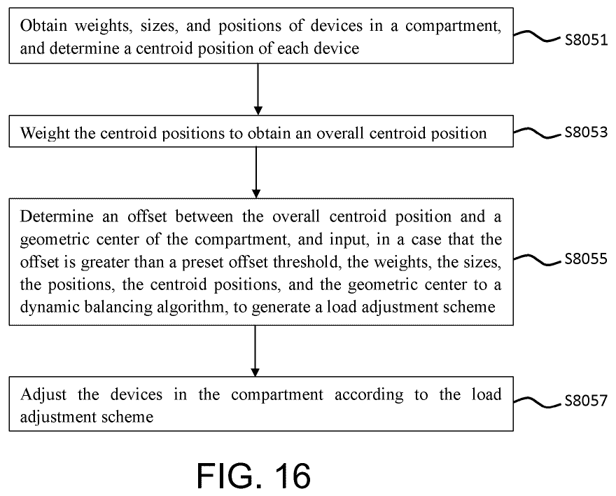

FIG. 16 is a flowchart of adjusting a structure of a compartment according to a structural design parameter according to an embodiment of the present application. The structural design parameter includes a redistributed load. The flow may include the following steps.

Step S8051: Obtain weights, sizes, and positions of devices in a compartment, and determine a centroid position of each device.

Specifically, each device is weighed by using a high-precision weighing device, and an exact weight of each device is recorded. A size of each device is measured by using a laser range finder or caliper, and length, width, and height data of each device are recorded. Accurate position coordinates of each device in the compartment are determined by using a three-dimensional coordinate measurement tool (such as a laser scanner or a total station). A centroid position of each device is calculated by using a formula according to the geometrical shape and mass distribution of the device.

For example, the device is a uniform cuboid. The centroid position is (x_{c}, y_{c}, z_{c}), where x_{c}=L/2, y_{c}=W/2, z_{c}=H/2, and L, W, and H are the length, width, and height of the cuboid, respectively.

The device is a uniform cylinder. The centroid position is (x_{c}, y_{c}, z_{c}), where x_{c}=D/2, y_{c}=D/2, z_{c}=H/2, D is the diameter of the cylinder, and H is the height of the cylinder.

The device is a uniform cone. The centroid position is (x_{c}, ye, z_{c}), where x_{c}=D/2, y_{c}=D/2, z_{c}=H/2, D is the diameter of the cone, and H is the height of the cone.

The device has an irregular shape. The centroid position is (x_{c}, y_{c}, z_{c}),

$${x}_{c} = \frac{1}{M} {\int }_{V} x \cdot ρ ( x , y , z ) dV , {y}_{c} = \frac{1}{M} {\int }_{V} y \cdot ρ ( x , y , z ) dV ,$$

$${z}_{c} = \frac{1}{M} {\int }_{V} z \cdot ρ ( x , y , z ) dV ,$$

where M is the total mass of the device, ρ(x, y, z) is the mass density distribution, and dV is a volume element.

The device is the distribution of different densities. The centroid position is (x_{c}, y_{c}, z_{c}),

$${x}_{c} = \frac{{\sum }_{i} {m}_{i} {x}_{i}}{{\sum }_{i} {m}_{i}} , {y}_{c} = \frac{{\sum }_{i} {m}_{i} {y}_{i}}{{\sum }_{i} {m}_{i}} , {z}_{c} = \frac{{\sum }_{i} {m}_{i} {z}_{i}}{{\sum }_{i} {m}_{i}} ,$$

where mᵢ is the mass of each block, and xᵢ, yᵢ, and zᵢ are the barycentric coordinates of each block.

Step S8053: Weight the centroid positions to obtain an overall centroid position.

Specifically, the contribution of the centroid position of each device to the overall centroid in x, y, z directions is calculated. Then, the contributions of all the devices in the x, y, z directions are summed, and the result is taken as the overall centroid position.

For example, stack mass m₁=10 kg, and barycentric coordinates (x₁, y₁, z₁)=(1, 2, 3) m. Cooling system mass m₂=20 kg, and barycentric coordinates (x₂, y₂, z₂)=(4, 5, 6) m. Heating system mass m₃=30 kg, and barycentric coordinates (x₃, y₃, z₃)=(7, 8, 9) m. The overall centroid position is:

$${x}_{cg , total} = ( 10 \times 1 + 20 \times 4 + 30 \times 7 ) / ( 10 + 20 + 30 ) = 310 / 60 = 5.17 m ;$$

$${y}_{cg , total} = ( 10 \times 2 + 20 \times 5 + 30 \times 8 ) / ( 10 + 20 + 30 ) = 340 / 60 = 5.67 m ;$$

$${z}_{cg , total} = ( 10 \times 3 + 20 \times 6 + 30 \times 9 ) / ( 10 + 20 + 30 ) = 390 / 60 = 6.5 m .$$

Step S8055: Determine an offset between the overall centroid position and a geometric center of the compartment, and input, in a case that the offset is greater than a preset offset threshold, the weights, the sizes, the positions, the centroid positions, and the geometric center to a dynamic balancing algorithm, to generate a load adjustment scheme.

Step S8057: Adjust the devices in the compartment according to the load adjustment scheme.

Specifically, during moving arrangements, it is critical to ensure that the overall centroid position of the compartment is aligned with the geometric center, which helps to keep stability and safety during transportation. A distance between the overall centroid position and the geometric center, namely an offset, is calculated, and may be calculated by using a Euclidean distance formula. A preset offset threshold is determined, which is a maximum offset allowed, beyond which the load may need to be adjusted. Here, the preset offset threshold is set to 2 meters, and parameters such as a weight, a size, a position, a centroid position, and a geometric center are input into the dynamic balancing algorithm. The algorithm calculates the load adjustment scheme to reduce the centroid offset. The dynamic balancing algorithm may be trained based on historical data.

Assuming that the geometric center of the compartment is (2, 1, 1.5), a current overall centroid calculation result is (2.5, 1.2, 1.8), and the offset is 0.62 meters. If the set threshold is 2 meters, the offset is within the threshold and does not need to be adjusted. Otherwise, the algorithm recommends moving parts of the object toward the geometric center, or adjusting the weight to reduce the offset.

Compared with the embodiment shown in FIG. 15, in this embodiment, basic data is provided for further calculating the centroid position by obtaining the weights, sizes, and positions of the devices in the compartment. Weighted calculation is performed on the centroid positions of all the devices, to obtain the overall centroid position. This weighting method combines mass and position data of all the devices, so that the overall centroid position can truly reflect the mass distribution of the devices in the whole compartment. The offset between the overall centroid position and the geometric center of the compartment is calculated, and compared with the preset threshold, to ensure the stability and safety of the compartment during transportation. If the offset exceeds the preset threshold, the dynamic balancing algorithm will generate the load adjustment scheme, to optimize the device layout to reduce a centroid offset, thereby improving the transportation stability of the compartment. Finally, according to the load adjustment scheme, the device is actually adjusted, to ensure that the overall centroid position is aligned with the geometric center. This not only improves the stability during transportation, but also effectively avoids potential safety hazards caused by the offset of the centroid.

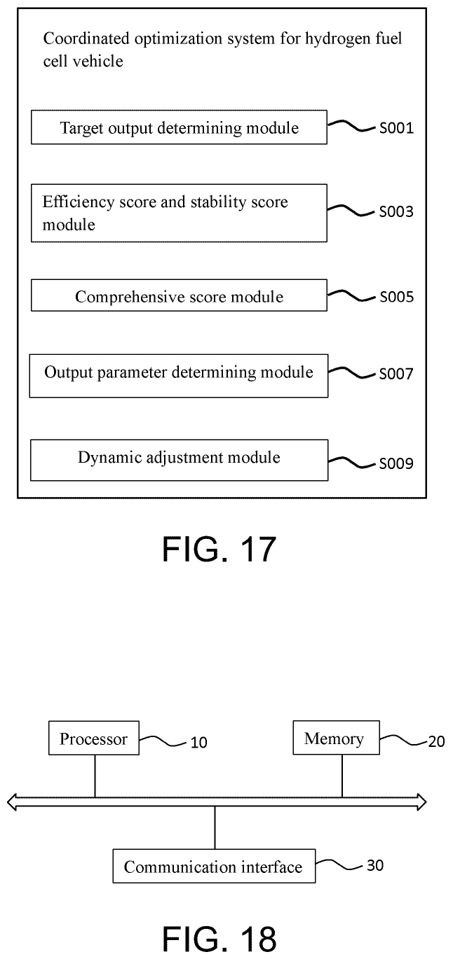

Correspondingly, FIG. 17 is a block diagram of a coordinated optimization system for a hydrogen fuel cell vehicle according to an embodiment of the present application. The system includes:
a target output determining module S001, configured to determine, based on an obtained target load demand of a hydrogen fuel cell vehicle, a target output voltage and a target output current corresponding to a stack in the hydrogen fuel cell vehicle, where the stack includes at least two sub-stacks connected in parallel;
an efficiency score and stability score module S003, configured to determine, for each sub-stack, a sub-stack efficiency score corresponding to the sub-stack and a sub-stack stability score corresponding to the sub-stack;
a comprehensive score module S005, configured to obtain a comprehensive score of the sub-stack efficiency score and the sub-stack stability score, and determine a primary stack and a secondary stack from the sub-stacks according to a comprehensive score result;
an output parameter determining module S007, configured to generate, according to the target output voltage and the target output current, a primary stack output parameter corresponding to the primary stack and a secondary stack output parameter corresponding to the secondary stack by using a preset output characteristic model; and
a dynamic adjustment module S009, configured to dynamically adjust an operating state of the primary stack according to the primary stack output parameter, and dynamically adjust an operating state of the secondary stack according to the secondary stack output parameter, to satisfy a target load demand.

Optionally, the target output determining module S001 includes:
a load demand obtaining unit, configured to obtain a current load demand of the hydrogen fuel cell vehicle;
a data smoothing unit, configured to perform data smoothing on the current load demand by using Kalman filtering, to obtain a smoothed target load demand; and
a target output determining unit, configured to generate, according to the target load demand, the target output voltage and the target output current corresponding to the stack by using a preset fuzzy rule library.

Optionally, the efficiency score and stability score module S003 for determining a sub-stack efficiency score corresponding to the sub-stack includes:
an obtaining unit, configured to obtain an output voltage, an output current, a hydrogen flow, and an oxygen flow of the sub-stack over a preset period of time;
an average output voltage and average output current determining unit, configured to determine an average output voltage of the output voltages over the preset period of time, and determine an average output current of the output currents over the preset period of time;
an average output power determining unit, configured to determine, according to the average output voltage and the average output current, an average output power corresponding to the sub-stack;
an average input power generating unit, configured to input the hydrogen flow and the oxygen flow to a preset power conversion model, to generate an average input power corresponding to the sub-stack; and
an efficiency score determining unit, configured to determine the sub-stack efficiency score according to a ratio of the average output power to the average input power.

Optionally, the efficiency score and stability score module S003 for determining a sub-stack stability score corresponding to the sub-stack includes:
an output voltage and output current obtaining unit, configured to obtain an output voltage and an output current of the sub-stack over a preset period of time;
a voltage standard deviation and current standard deviation determining unit, configured to determine a voltage standard deviation of the output voltage over the preset period of time, and determine a current standard deviation of the output current over the preset period of time; and
a stability score determining unit, configured to determine, according to the voltage standard deviation and the current standard deviation, the sub-stack stability score by using a preset stability score model.

Optionally, the comprehensive score module S005 includes:
a comprehensive score unit, configured to weight the sub-stack efficiency score and the sub-stack stability score, to obtain a comprehensive score;
a clustering unit, configured to cluster the sub-stacks to obtain stack clusters separately including one or more sub-stacks;
a representative feature determining unit, configured to determine intra-cluster representative features of the stack clusters, and determine, for any stack cluster, a stack feature set to which the intra-cluster representative features belong;
a candidate stack determining unit, configured to obtain risk factors of the stack feature sets, and screen out a candidate stack feature set based on the risk factors; and
a primary-secondary stack determining unit, configured to sort the comprehensive scores of the sub-stacks in descending order in the stack cluster corresponding to the candidate stack feature set, determine a sub-stack corresponding to the highest comprehensive score as the primary stack, and determine the remaining sub-stack as the secondary stack.

Optionally, the preset output characteristic model includes a support vector machine, a decision tree, and a random forest. The primary stack output parameter includes a primary output voltage, a primary output current, and a primary output power. The secondary output parameter includes a secondary output voltage, a secondary output current, and a secondary output power. The output parameter determining module S007 includes:
an output voltage unit, configured to generate, according to the target output voltage and the target output current, a primary output voltage corresponding to the primary stack and a secondary output voltage corresponding to the secondary stack by using the support vector machine;
an output current unit, configured to generate, according to the target output voltage and the target output current, a primary output current corresponding to the primary stack and a secondary output current corresponding to the secondary stack by using the decision tree; and
an output power unit, configured to generate, according to the target output voltage and the target output current, a primary output power corresponding to the primary stack and a secondary output power corresponding to the secondary stack by using the random forest.

Optionally, following the dynamic adjustment module S009, the system is further configured to:
compare the primary output voltage with the target output voltage, and re-adjust, in a case that a difference in a comparison result exceeds a voltage deviation threshold, the operating state of the primary stack and the operating state of the secondary stack; and
compare the primary output current with the target output current, and re-adjust, in a case that a difference in a comparison result exceeds a current deviation threshold, the operating state of the primary stack and the operating state of the secondary stack.

Optionally, the system further includes:
a performance parameter obtaining module, configured to obtain, in a case that the stack is used in cooperation with a plurality of auxiliary power supplies, performance parameters of the auxiliary power supplies;
an output power range determining module, configured to determine, according to the performance parameters, output power ranges corresponding to the auxiliary power supplies by using a preset performance-power range model; and
a power distribution scheme generating module, configured to generate, according to a multi-objective optimization algorithm, an optimized power distribution scheme by maximizing a power supply efficiency, a device power supply reliability, and a device life as objective functions and by constraining output powers of the auxiliary power supplies to satisfy the output power range, where the device power supply reliability represents a proportion of time during which the target load demand is maintained.

Optionally, the auxiliary power supplies include a generator, a solar panel, and a lithium-ion battery stack.

The performance parameters include a power generation efficiency of the generator, a maximum output power of the solar panel, and a capacity of the lithium-ion battery pack.

Optionally, the generating, according to a multi-objective optimization algorithm, an optimized power distribution scheme further includes satisfying the following conditions.

The target load demand is equal to a sum of the output powers of the stacks and the output powers of the auxiliary power supplies.

The output power of each sub-stack is required to be within a design limit range.

Optionally, the objective function includes:

$$min {\sum }_{t = 1}^{24} [ {w}_{1} \times {a}_{i} + {w}_{2} \times {b}_{i} + {w}_{3} \times {c}_{i} ]$$

power supply efficiency=output power of stack or auxiliary power supply/target load demand,
where w₁, w₂, and w₃ are weight coefficients, αᵢ is the power supply efficiency of an i^{th} sub-stack or auxiliary power supply, bᵢ is the device power supply reliability of the i^{th} sub-stack or auxiliary power supply, and cᵢ is the device life of the i^{th} sub-stack or auxiliary power supply.

Optionally, the system further includes:
a membership determining module, configured to obtain a temperature change rate and a current load power of each sub-stack, and determine a temperature change trend membership corresponding to the sub-stack by using a fuzzy logic algorithm, where the temperature change trend membership is configured for representing a fuzzification degree of a temperature change trend;
an adjusted power generating module, configured to generate, according to the current load power and the temperature change trend membership, an adjusted power corresponding to the sub-stack; and
an adjusted power adjusting module, configured to dynamically adjust, according to the adjusted power, a flow, pressure, and temperature of hydrogen, a flow, pressure, and temperature of oxygen, and a flow, pressure, and temperature of water in the sub-stack.

Optionally, the system further includes:
a function adjusting module, configured to adjust, in a case that the temperature change rate exceeds a preset temperature change threshold, a membership function in the fuzzy logic algorithm, to obtain an adjusted fuzzy logic algorithm;
an updated membership determining module, configured to determine, according to the adjusted fuzzy logic algorithm, an updated temperature change trend membership corresponding to the sub-stack;
an updated adjusted power generating module, configured to generate, according to the current load power and the updated temperature change trend membership, an updated adjusted power corresponding to the sub-stack; and
an updated adjusted power adjusting module, configured to dynamically adjust, according to the updated adjusted power, the flow, pressure, and temperature of hydrogen, the flow, pressure, and temperature of oxygen, and the flow, pressure, and temperature of water in the sub-stack.

Optionally, the system further includes:
a current runtime determining module, configured to determine a current runtime corresponding to the sub-stack;
a predicted load power demand determining module, configured to determine, according to the target load demand, a predicted load power demand corresponding to the sub-stack over a future period of time by using a dynamic programming algorithm with an objective of prolonging the current runtime; and
a dynamic adjustment module, configured to dynamically adjust, according to the predicted load power demand, a flow, pressure, and temperature of hydrogen, a flow, pressure, and temperature of oxygen, and a flow, pressure, and temperature of water in the sub-stack.

Optionally, the current runtime determining module is configured to:
obtain a current hydrogen inventory, a sub-stack efficiency, and a peak power demand of each sub-stack;
determine, according to the peak power demand and the sub-stack efficiency, a required hydrogen amount corresponding to the sub-stack; and
determine, according to the current hydrogen inventory and the required hydrogen amount, the current runtime corresponding to the sub-stack.

Optionally, the dynamic programming algorithm includes:
determining, according to the predicted load power demand and the sub-stack efficiency, a predicted required hydrogen amount corresponding to the sub-stack;
determining a predicted runtime according to the current hydrogen inventory and the predicted required hydrogen amount; and
continuing to iteratively cycle, in a case that the predicted runtime is lower than the current runtime, the dynamic programming algorithm until the predicted runtime exceeds the current runtime, to obtain a predicted load power demand corresponding to the sub-stack.

Optionally, the system further includes:
a temperature obtaining module, configured to obtain a current operating temperature and a current ambient temperature of the sub-stack;
a heating and water storage module, configured to enable, in a case that the current operating temperature is lower than a preset operating temperature threshold and/or the current ambient temperature is lower than a preset ambient temperature threshold, a drainage heating function and a water storage and return function;
a monitoring module, configured to monitor a liquid flow in a drainage heating process and a liquid level in a water storage and return process; and
a heating power and stored water recovery rate determining and adjusting module, configured to determine an adjusted heating power and a stored water recovery rate according to the liquid flow and the liquid level, and perform dynamic adjustment according to the heating power and the stored water recovery rate.

Optionally, the system further includes:
a load power demand determining module, configured to obtain a present current density, a current operating temperature, a temperature change rate, and a temperature change gradient of the sub-stack, and determine a load power demand corresponding to the sub-stack by using a preset first fuzzy control algorithm in combination with the target load demand;
an adjusted current density determining module, configured to determine, according to the load power demand and the temperature change gradient, an adjusted current density corresponding to the sub-stack by using a preset second fuzzy control algorithm; and
an adjusted current density adjusting module, configured to dynamically adjust, according to the adjusted current density, a flow, pressure, and temperature of hydrogen, a flow, pressure, and temperature of oxygen, and a flow, pressure, and temperature of water in the sub-stack.

Optionally, the system further includes:
a matrix construction module, configured to obtain weight distribution data of a compartment of the hydrogen fuel cell vehicle, and construct a weight distribution matrix according to the weight distribution data, where the weight distribution matrix is configured for representing weight data of different regions of the compartment;
an analysis module, configured to analyze, according to the weight distribution matrix, the compartment by using finite element software, to obtain an overweight region; and
a parameter adjustment module, configured to adjust, according to the overweight region, a structural design parameter of the compartment by using the finite element software, and adjust a structure of the compartment according to the structural design parameter.

Optionally, the structural design parameter includes a redistributed load. The adjusting a structure of the compartment according to the structural design parameter includes:
obtaining weights, sizes, and positions of devices in the compartment, and determining a centroid position of each device;
weighting the centroid positions to obtain an overall centroid position;
determining an offset between the overall centroid position and a geometric center of the compartment, and inputting, in a case that the offset is greater than a preset offset threshold, the weights, the sizes, the positions, the centroid positions, and the geometric center to a dynamic balancing algorithm, to generate a load adjustment scheme; and
adjusting the devices in the compartment according to the load adjustment scheme.

Further functional descriptions of the foregoing modules and units are the same as those of the foregoing corresponding embodiments, and will not be repeated herein.

A coordinated optimization system for a hydrogen fuel cell vehicle in this embodiment is presented in the form of a functional unit. The unit here refers to an application specific integrated circuit (ASIC), a processor and a memory that execute one or more software or fixed programs, and/or other devices capable of providing the foregoing functions.

Reference is made to FIG. 18. FIG. 18 is a schematic structural diagram of a computer device according to an embodiment of the present application. As shown in FIG. 18, the computer device includes one or more processors 10, a memory 20, and interfaces for connecting various components, including a high-speed interface and a low-speed interface. The various components are in communication connection with each other by using different buses and may be mounted on a common motherboard or otherwise as desired. The processor may process instructions executed within the computer device, including instructions stored in or on the memory to display graphical information of a GUI on an external input/output apparatus (such as a display device coupled to the interface). In some optional implementations, a plurality of processors and/or a plurality of buses may be used with a plurality of memories and a plurality of memories, if desired. Similarly, a plurality of computer devices may be connected. Each device provides some necessary operations (e.g., as an array of servers, a set of blade servers, or a multi-processor system). In FIG. 18, one processor 10 is, for example, included.

The processor 10 may be a central processing unit, a network processor, or a combination thereof. The processor 10 may further include a hardware chip. The hardware chip may be an ASIC, a programmable logic device, or a combination thereof. The programmable logic device may be a complex programmable logic device, a field programmable logic gate array, a generic array logic, or any combination thereof.

The memory 20 stores instructions executable by at least one processor 10, to cause the at least one processor 10 to perform the method illustrated in the foregoing embodiment.

The memory 20 may include a program storage region and a data storage region, where the program storage region may store an application required for an operating system and at least one function, and the data storage region may store data created according to the use of the computer device. In addition, the memory 20 may include a high-speed random access memory and may further include a non-volatile memory, such as at least one disk storage device, a flash device, or another non-volatile solid-state storage device. In some optional implementations, the memory 20 optionally includes memories disposed remotely with respect to the processor 10. The memories may be connected to the computer device over a network. Examples of the foregoing network include, but are not limited to, the Internet, the Intranet, a local area network, a mobile communication network, and combinations thereof.

The memory 20 may include a volatile memory, such as a random access memory. The memory may include a non-volatile memory, such as a flash memory, a hard drive, or a solid-state drive. The memory 20 may further include a combination of the foregoing types of memories.

The computer device further includes a communication interface 30 for the computer device to communicate with other devices or a communication network.

An embodiment of the present application further provides a computer-readable storage medium. The method according to the foregoing embodiment of the present application may be implemented in hardware or firmware, or as a computer code that may be recorded in a storage medium, or downloaded over a network, originally stored in a remote storage medium or a non-volatile machine-readable storage medium, and to be stored in a local storage medium, so that the method described herein may be processed by such software stored in a storage medium using a general-purpose computer, a special-purpose processor, or programmable or special-purpose hardware. The storage medium may be a disk, an optical disc, a read-only memory, a random access memory, a flash memory, a hard drive, or a solid-state drive. Further, the storage medium may include a combination of the foregoing types of memories. It will be appreciated that a computer, a processor, a microprocessor controller, or programmable hardware includes a storage component that may store or receive software or computer code that, when accessed and executed by the computer, the processor, or the hardware, implements the method illustrated in the foregoing embodiment.

The system, apparatus, module, or unit described in the foregoing embodiments may be implemented by a computer chip or entity, or by a product having a function. A typical implementation device is a computer. Specifically, the computer may be, for example, a personal computer, a laptop computer, a cellular phone, a camera phone, a smartphone, a personal digital assistant, a media player, a navigation device, an email device, a game console, a tablet computer, a wearable device, or any combination of these devices.

For convenience of description, when describing the above apparatus, the apparatus is divided into various units in terms of functions, which are described separately. Certainly, the functions of each unit may be implemented in the same or more pieces of software and/or hardware in the implementation of the present application.

It will be appreciated by those skilled in the art that embodiments of the present application may be provided as methods, systems, or computer program products. Accordingly, the present application may take the form of an entirely hardware embodiment, an entirely software embodiment, or an embodiment combining software and hardware. Furthermore, the present application may take the form of a computer program product implemented in one or more computer-available storage media (including, but not limited to, a disk memory, a CD-ROM, and an optical memory) containing computer-available program code therein.

The present application is described with reference to flowcharts and/or block diagrams of methods, devices (systems), and computer program products according to the embodiments of the present application. It should be understood that each flow and/or block in the flowcharts and/or block diagrams, as well as combinations of the flows and/or blocks in the flowcharts and/or block diagrams, may be implemented by computer program instructions. These computer program instructions may be provided to a processor of a general-purpose computer, a special-purpose computer, an embedded processor, or another programmable data processing device to produce a machine such that the instructions executed by the processor of the computer or another programmable data processing device produce an apparatus for implementing the functions specified in one or more flows in the flowcharts and/or one or more blocks in the block diagrams.

These computer program instructions may alternatively be stored in a computer-readable memory capable of directing the computer or another programmable data processing device to operate in a particular manner such that the instructions stored in the computer-readable memory produce an article of manufacture including an instruction apparatus for implementing the functions specified in one or more flows in the flowcharts and/or one or more blocks in the block diagrams.

These computer program instructions may further be loaded onto the computer or another programmable data processing device such that a series of operational steps are performed on the computer or another programmable device to produce a computer-implemented process. Therefore, the instructions executed on the computer or another programmable device provide steps for implementing the functions specified in one or more flows in the flowcharts and/or one or more blocks in the block diagrams.

It should also be noted that the terms “include,” “comprise,” or any other variation thereof are intended to contain non-exclusive inclusion, so that processes, methods, articles, or devices including a series of elements not only include those elements, but also include other elements which are not clearly listed, or further include inherent elements of the processes, methods, articles, or devices. Without more limitations, an element defined by a sentence “including a” does not exclude a case that there are still other same elements in the processes, methods, articles, or devices that include the element.

The various embodiments of this specification are all described in a progressive manner. For same or similar parts in the various embodiments, reference is made to these embodiments. Descriptions of each embodiment focus on a difference from other embodiments. Especially, a system embodiment is basically similar to a method embodiment, and therefore is described briefly. For related parts, reference may be made to partial descriptions in the method embodiment.

The foregoing descriptions are merely embodiments of the present application and are not intended to limit the protection scope of the present application. For those skilled in the art, the present application may have various changes and variations. Any modification, equivalent replacement, improvement, and the like made within the spirit and principle of the present application should be included within the scope of the claims of the present application.

Although the embodiments of the present application have been described in conjunction with the accompanying drawings, various modifications and variations may be made by those skilled in the art without departing from the spirit and scope of the present application. Such modifications and variations fall within the scope defined by the appended claims.

What is claimed is:

1. A coordinated optimization method for a hydrogen fuel cell vehicle, the method comprising:
determining, based on an obtained target load demand of the hydrogen fuel cell vehicle, a target output voltage and a target output current corresponding to a stack in the hydrogen fuel cell vehicle, wherein the stack comprises at least two sub-stacks connected in parallel;
determining, for each of the sub-stacks, a sub-stack efficiency score corresponding to the sub-stacks and a sub-stack stability score corresponding to the sub-stacks, wherein the sub-stack efficiency score is configured for representing a ratio of an average output power of the sub-stacks to an average input power over a specific period of time, and the sub-stack stability score is configured for representing a degree of fluctuation of an output voltage and an output current of the sub-stacks over the specific period of time;
obtaining a comprehensive score of the sub-stack efficiency score and the sub-stack stability score, clustering the sub-stacks to obtain stack clusters separately comprising one or more the sub-stacks, determining intra-cluster representative features of the stack clusters, determining, for any one of the stack clusters, stack feature sets to which the intra-cluster representative features belong, obtaining risk factors of the stack feature sets, screening out a candidate stack feature set based on the risk factors, sorting comprehensive scores of the sub-stacks in descending order in stack cluster corresponding to the candidate stack feature set, and determining a primary stack and a secondary stack from the sub-stacks according to a comprehensive score result, wherein the risk factors of the stack feature sets are evaluated based on stability and fault risk factors;
generating, according to the target output voltage and the target output current, a primary stack output parameter corresponding to the primary stack and a secondary stack output parameter corresponding to the secondary stack by using a preset output characteristic model; and
dynamically adjusting an operating state of the primary stack according to the primary stack output parameter, and dynamically adjusting an operating state of the secondary stack according to the secondary stack output parameter, to satisfy a target load demand.

2. The method according to claim 1, wherein the determining, based on the obtained target load demand of the hydrogen fuel cell vehicle, the target output voltage and the target output current corresponding to the stack in the hydrogen fuel cell vehicle comprises:
obtaining a current load demand of the hydrogen fuel cell vehicle;
performing data smoothing on the current load demand by using Kalman filtering, to obtain a smoothed target load demand; and
generating, according to the target load demand, the target output voltage and the target output current corresponding to the stack by using a preset fuzzy rule library.

3. The method according to claim 1, wherein the determining the sub-stack efficiency score corresponding to the sub-stacks comprises:
obtaining an output voltage, an output current, a hydrogen flow, and an oxygen flow of the sub-stacks over a preset period of time;
determining an average output voltage of the output voltage over the preset period of time, and determining an average output current of the output current over the preset period of time;
determining, according to the average output voltage and the average output current, the average output power corresponding to the sub-stacks;
inputting the hydrogen flow and the oxygen flow to a preset power conversion model, to generate the average input power corresponding to the sub-stacks; and
determining the sub-stack efficiency score according to the ratio of the average output power to the average input power.

4. The method according to claim 1, wherein the determining the sub-stack stability score corresponding to the sub-stacks comprises:
obtaining the output voltage and an output current of the sub-stacks over a preset period of time;
determining a voltage standard deviation of the output voltage over the preset period of time, and determining a current standard deviation of the output current over the preset period of time; and
determining, according to the voltage standard deviation and the current standard deviation, the sub-stack stability score by using a preset stability score model.

5. The method according to claim 1, wherein the obtaining the comprehensive score of the sub-stack efficiency score and the sub-stack stability score, and determining the primary stack and the secondary stack from the sub-stacks according to the comprehensive score result comprises:
weighting the sub-stack efficiency score and the sub-stack stability score, to obtain the comprehensive score; and
determining the sub-stacks corresponding to a highest comprehensive score as the primary stack, and determining the remaining sub-stack as the secondary stack.

6. The method according to claim 1, wherein the preset output characteristic model comprises a support vector machine, a decision tree, and a random forest; the primary stack output parameter comprises a primary output voltage, a primary output current, and a primary output power; secondary output parameter comprises a secondary output voltage, a secondary output current, and a secondary output power; and the generating, according to the target output voltage and the target output current, a primary stack output parameter corresponding to the primary stack and the secondary stack output parameter corresponding to the secondary stack by using the preset output characteristic model comprises:
generating, according to the target output voltage and the target output current, a primary output voltage corresponding to the primary stack and a secondary output voltage corresponding to the secondary stack by using the support vector machine;
generating, according to the target output voltage and the target output current, a primary output current corresponding to the primary stack and a secondary output current corresponding to the secondary stack by using the decision tree; and
generating, according to the target output voltage and the target output current, a primary output power corresponding to the primary stack and a secondary output power corresponding to the secondary stack by using the random forest.

7. The method according to claim 6, wherein after the dynamically adjusting the operating state of the primary stack according to the primary stack output parameter, and dynamically adjusting the operating state of the secondary stack according to the secondary stack output parameter, the method further comprises:
comparing the primary output voltage with the target output voltage, and re-adjusting, in a case that a difference in a comparison result exceeds a voltage deviation threshold, the operating state of the primary stack and the operating state of the secondary stack; and
comparing the primary output current with the target output current, and re-adjusting, in a case that a difference in a comparison result exceeds a current deviation threshold, the operating state of the primary stack and the operating state of the secondary stack.

8. The method according to claim 1, further comprising:
obtaining, in a case that the stack is used in cooperation with a plurality of auxiliary power supplies, performance parameters of the auxiliary power supplies;
determining, according to the performance parameters, output power ranges corresponding to the auxiliary power supplies by using a preset performance-power range model; and
generating, according to a multi-objective optimization algorithm, an optimized power distribution scheme by maximizing a power supply efficiency, a device power supply reliability, and a device life as objective functions and by constraining output powers of the auxiliary power supplies to satisfy the output power range, wherein the device power supply reliability represents a proportion of time during which the target load demand is maintained.

9. The method according to claim 8, wherein the auxiliary power supplies comprise a generator, a solar panel, and a lithium-ion battery stack; and
the performance parameters comprise a power generation efficiency of the generator, a maximum output power of the solar panel, and a capacity of lithium-ion battery pack.

10. The method according to claim 8, wherein the generating, according to a multi-objective optimization algorithm, an optimized power distribution scheme further comprises satisfying the following conditions:
the target load demand is equal to a sum of the output powers of the stack and the output powers of the auxiliary power supplies; and
the output power of each of the sub-stacks is required to be within a design limit range.

11. The method according to claim 8, wherein the objective function comprises:
$$min {\sum }_{t = 1}^{24} [ {w}_{1} \times {a}_{i} + {w}_{2} \times {b}_{i} + {w}_{3} \times {c}_{i} ] ,$$
power supply efficiency=output power of the stack or auxiliary power supply/target load demand,
wherein w₁, w₂, and w₃ are weight coefficients, αᵢ is the power supply efficiency of an i^{th} sub-stack or auxiliary power supply, bᵢ is the device power supply reliability of the i^{th} sub-stack or auxiliary power supply, and cᵢ is the device life of the i^{th} sub-stack or auxiliary power supply.

12. The method according to claim 1, further comprising:
obtaining a temperature change rate and a current load power of each of the sub-stacks, and determining a temperature change trend membership corresponding to the sub-stacks by using a fuzzy logic algorithm, wherein the temperature change trend membership is configured for representing a fuzzification degree of a temperature change trend;
generating, according to the current load power and the temperature change trend membership, an adjusted power corresponding to the sub-stacks; and
dynamically adjusting, according to the adjusted power, a flow, pressure, and temperature of hydrogen, a flow, pressure, and temperature of oxygen, and a flow, pressure, and temperature of water in the sub-stacks.

13. The method according to claim 12, further comprising:
adjusting, in a case that the temperature change rate exceeds a preset temperature change threshold, a membership function in the fuzzy logic algorithm, to obtain an adjusted fuzzy logic algorithm;
determining, according to the adjusted fuzzy logic algorithm, an updated temperature change trend membership corresponding to the sub-stacks;
generating, according to the current load power and the updated temperature change trend membership, an updated adjusted power corresponding to the sub-stacks; and
dynamically adjusting, according to the updated adjusted power, the flow, pressure, and temperature of hydrogen, the flow, pressure, and temperature of oxygen, and the flow, pressure, and temperature of water in the sub-stacks.

14. The method according to claim 1, further comprising:
determining a current runtime corresponding to the sub-stacks;
determining, according to the target load demand, a predicted load power demand corresponding to the sub-stacks over a future period of time by using a dynamic programming algorithm with an objective of prolonging the current runtime; and
dynamically adjusting, according to the predicted load power demand, a flow, pressure, and temperature of hydrogen, a flow, pressure, and temperature of oxygen, and a flow, pressure, and temperature of water in the sub-stacks.

15. The method according to claim 14, wherein the determining a current runtime corresponding to the sub-stacks comprises:
obtaining a current hydrogen inventory, a sub-stack efficiency, and a peak power demand of each of the sub-stacks;
determining, according to the peak power demand and the sub-stack efficiency, a required hydrogen amount corresponding to the sub-stacks; and
determining, according to the current hydrogen inventory and the required hydrogen amount, the current runtime corresponding to the sub-stacks.

16. The method according to claim 14, wherein the dynamic programming algorithm comprises:
determining, according to the predicted load power demand and the sub-stack efficiency, a predicted required hydrogen amount corresponding to the sub-stacks;
determining a predicted runtime according to a current hydrogen inventory and the predicted required hydrogen amount; and
continuing to iteratively cycle, in a case that the predicted runtime is lower than the current runtime, the dynamic programming algorithm until the predicted runtime exceeds the current runtime, to obtain a predicted load power demand corresponding to the sub-stacks.

17. The method according to claim 1, further comprising:
obtaining a current operating temperature and a current ambient temperature of the sub-stacks;
enabling, in a case that the current operating temperature is lower than a preset operating temperature threshold and/or the current ambient temperature is lower than a preset ambient temperature threshold, a drainage heating function and a water storage and return function;
monitoring a liquid flow in a drainage heating process and a liquid level in a water storage and return process; and
determining an adjusted heating power and a stored water recovery rate according to the liquid flow and the liquid level, and performing dynamic adjustment according to the heating power and the stored water recovery rate.

18. The method according to claim 1, further comprising:
obtaining a present current density, a current operating temperature, a temperature change rate, and a temperature change gradient of the sub-stacks, and determining a load power demand corresponding to the sub-stacks by using a preset first fuzzy control algorithm in combination with the target load demand;
determining, according to the load power demand and the temperature change gradient, an adjusted current density corresponding to the sub-stacks by using a preset second fuzzy control algorithm; and
dynamically adjusting, according to the adjusted current density, a flow, pressure, and temperature of hydrogen, a flow, pressure, and temperature of oxygen, and a flow, pressure, and temperature of water in the sub-stacks.

19. The method according to claim 1, further comprising:
obtaining weight distribution data of a compartment of the hydrogen fuel cell vehicle, and constructing a weight distribution matrix according to the weight distribution data, wherein the weight distribution matrix is configured for representing weight data of different regions of the compartment;
analyzing, according to the weight distribution matrix, the compartment by using finite element software, to obtain an overweight region; and
adjusting, according to the overweight region, a structural design parameter of the compartment by using the finite element software, and adjusting a structure of the compartment according to the structural design parameter.

20. The method according to claim 19, wherein the structural design parameter comprises a redistributed load, and the adjusting a structure of the compartment according to the structural design parameter comprises:
obtaining weights, sizes, and positions of devices in the compartment, and determining a centroid position of each device;
weighting centroid positions to obtain an overall centroid position;
determining an offset between the overall centroid position and a geometric center of the compartment, and inputting, in a case that the offset is greater than a preset offset threshold, the weights, the sizes, the positions, the centroid positions, and the geometric center to a dynamic balancing algorithm, to generate a load adjustment scheme; and
adjusting the devices in the compartment according to the load adjustment scheme.

21. A coordinated optimization system for a hydrogen fuel cell vehicle, the system comprising:
a target output determining module, configured to determine, based on an obtained target load demand of the hydrogen fuel cell vehicle, a target output voltage and a target output current corresponding to a stack in the hydrogen fuel cell vehicle, wherein the stack comprises at least two sub-stacks connected in parallel;
an efficiency score and stability score module, configured to determine, for each of the sub-stacks, a sub-stack efficiency score corresponding to the sub-stacks and a sub-stack stability score corresponding to the sub-stacks, wherein the sub-stack efficiency score is configured for representing a ratio of an average output power of the sub-stacks to an average input power over a specific period of time, and the sub-stack stability score is configured for representing a degree of fluctuation of an output voltage and an output current of the sub-stacks over the specific period of time;
a comprehensive score module, configured to obtain a comprehensive score of the sub-stack efficiency score and the sub-stack stability score, cluster the sub-stacks to obtain stack clusters separately comprising one or more sub-stacks, determine intra-cluster representative features of the stack clusters, determine, for any stack cluster, stack feature sets to which the intra-cluster representative features belong, obtain risk factors of the stack feature sets, screen out a candidate stack feature set based on the risk factors, sort comprehensive scores of the sub-stacks in descending order in the stack cluster corresponding to the candidate stack feature set, and determine a primary stack and a secondary stack from the sub-stacks according to a comprehensive score result, wherein the risk factors of the stack feature sets are evaluated based on stability and fault risk factors;
an output parameter determining module, configured to generate, according to the target output voltage and the target output current, a primary stack output parameter corresponding to the primary stack and a secondary stack output parameter corresponding to the secondary stack by using a preset output characteristic model; and
a dynamic adjustment module, configured to dynamically adjust an operating state of the primary stack according to the primary stack output parameter, and dynamically adjust an operating state of the secondary stack according to the secondary stack output parameter, to satisfy a target load demand.

22. A computer device, comprising:
a memory and a processor, the memory and the processor being in communication connection with each other, the memory having computer instructions stored therein, and the processor executing the computer instructions to perform a coordinated optimization method for the hydrogen fuel cell vehicle according to claim 1.

23. A computer-readable storage medium, the computer-readable storage medium having computer instructions stored therein, and the computer instructions causing a computer to perform a coordinated optimization method for the hydrogen fuel cell vehicle according to claim 1.
